(19) United States
(12) Patent Application Publication
(10) Pub. No.: US 2026/0331849 A1
(43) Pub. Date: Oct. 22, 2026

(54) ELECTRICAL CONNECTOR AND CABLE ASSEMBLY

(71) Applicant: EZCONN CORPORATION, New Taipei City (TW)

(72) Inventors: Chi Bin HUANG, New Taipei City (TW); Han-Chung CHEN, New Taipei City (TW); David LACEY, New Taipei City (TW)

(73) Assignee: EZCONN CORPORATION, New Taipei City (TW)

(21) Appl. No.: 19/186,237

(22) Filed: Apr. 22, 2025

(51) Int. Cl. H01R 24/40; H01R 103/00

(52) U.S. Cl. CPC H01R 24/40; H01R 2103/00

(57) ABSTRACT

An electrical connector includes a casing and an inner pressing sleeve. The casing includes a housing portion and a pressing portion, the housing portion has an installation space, and the pressing portion is at least partially located in the installation space. The inner pressing sleeve is located in the installation space and includes an annular fastening portion and at least one elastic clamping portion connected to each other. The annular fastening portion is slidable relative to the housing portion for allowing the elastic clamping portion to form an installation through hole when the elastic clamping portion is not pressed by the pressing portion and allowing the elastic clamping portion to form a clamping hole when the elastic clamping portion is pressed by the pressing portion. An inner diameter of the installation through hole is greater than an inner diameter of the clamping hole.

### CROSS-REFERENCE TO RELATED APPLICATIONS

This non-provisional application claims priority under 35 U.S.C. § 119(a) on Provisional Application No(s). 63/638,313 filed in U.S.A. on Apr. 24, 2024, the entire contents of which are hereby incorporated by reference.

### TECHNICAL FIELD

The disclosure relates to an electrical connector and a cable assembly.

### BACKGROUND

In general, during the assembly of a cable to an electrical connector, users need to fold back the braided mesh layer of the cable in order to facilitate the insertion of the inner sleeve of the electrical connector between the insulation layer and the braided mesh layer of the cable, thereby ensuring electrical contact between the inner sleeve and the braided mesh layer. However, such an assembly method leads to low assembly efficiency. Therefore, researchers in the field are working on addressing the aforementioned issue.

### SUMMARY

The disclosure provides an electrical connector and a cable assembly which enable the assembly efficiency of the cable assembly to be improved.

One embodiment of the disclosure provides an electrical connector. The electrical connector is configured to be assembled with a cable. The electrical connector includes a casing and an inner pressing sleeve. The casing includes a housing portion and a pressing portion, the housing portion has an installation space, and the pressing portion is at least partially located in the installation space. The inner pressing sleeve is located in the installation space and includes an annular fastening portion and at least one elastic clamping portion connected to each other. The annular fastening portion is slidable relative to the housing portion for allowing the at least one elastic clamping portion to form an installation through hole when the at least one elastic clamping portion is not pressed by the pressing portion and allowing the at least one elastic clamping portion to form a clamping hole when the at least one elastic clamping portion is pressed by the pressing portion. An inner diameter of the installation through hole is greater than an inner diameter of the clamping hole.

Another embodiment of the disclosure provides a cable assembly. The cable assembly includes an electrical connector and a cable. The electrical connector includes a casing and an inner pressing sleeve. The casing includes a housing portion and a pressing portion, the housing portion has an installation space, and the pressing portion is at least partially located in the installation space. The inner pressing sleeve is slidably located in the installation space and includes an annular fastening portion and at least one elastic clamping portion connected to each other. The cable is mounted into the inner pressing sleeve through the installation space of the housing portion, and the at least one elastic clamping portion is pressed by the pressing portion so as to form a clamping hole to clamp the cable.

According to the electrical connector and the cable assembly as discussed in the above embodiments, the annular fastening portion of the inner pressing sleeve is slidable relative to the housing portion of the casing, allowing the elastic clamping portions to form the installation through hole when not pressed by the pressing portion of the casing and to form the clamping hole when pressed by the pressing portion, and the inner diameter of the installation through hole is greater than the inner diameter of the clamping hole. This arrangement allows, during the process of inserting the cable into the inner pressing sleeve through the installation space of the housing portion, the elastic clamping portions of the inner pressing sleeve to be pressed by the pressing portion of the casing, thereby tightly clamping the braided mesh layer of the cable. In this way, the braided mesh layer of the cable does not need to be folded back, as the elastic clamping portions of the inner pressing sleeve are pressed by the pressing portion of the casing to tightly clamp the braided mesh layer of the cable, ensuring an electrical contact between the inner pressing sleeve and the braided mesh layer of the cable. Therefore, the step of folding back the braided mesh layer of the cable during the assembly of the cable to the electrical connector is saved, improving the assembly efficiency.

### BRIEF DESCRIPTION OF THE DRAWINGS

The present disclosure will become better understood from the detailed description given herein below and the accompanying drawings which are given by way of illustration only and thus are not intending to limit the present disclosure and wherein:

FIG. 1 is a perspective view of an electrical connector according to a first embodiment of the disclosure;

FIG. 2 is an exploded view of the electrical connector in FIG. 1;

FIG. 3 is a perspective view of an inner pressing sleeve in FIG. 2;

FIG. 4 is a cross-sectional view of the electrical connector in FIG. 1;

FIG. 5 is a cross-sectional view of the electrical connector in FIG. 4 which is assembled with a cable;

FIG. 6 is an exploded view of an electrical connector according to a second embodiment of the disclosure;

FIG. 7 is a perspective view of an inner pressing sleeve in FIG. 6;

FIG. 8 is a cross-sectional view of the electrical connector in FIG. 6;

FIG. 9 is a cross-sectional view of the electrical connector taken along a line 9-9 in FIG. 8;

FIG. 10 is a cross-sectional view of the electrical connector in FIG. 8 which is assembled with a cable;

FIG. 11 is a cross-sectional view of the electrical connector taken along a line 11-11 in FIG. 10;

FIG. 12 is an exploded view of an electrical connector according to a third embodiment of the disclosure;

FIG. 13 is a perspective view of an inner pressing sleeve in FIG. 12;

FIG. 14 is a cross-sectional view of the electrical connector in FIG. 12;

FIG. 15 is a cross-sectional view of the electrical connector in FIG. 12 which is assembled with a cable;

FIG. 16 is an exploded view of an electrical connector according to a fourth embodiment of the disclosure;

FIG. 17 is a perspective view of an inner pressing sleeve in FIG. 16;

FIG. 18 is a cross-sectional view of the electrical connector in FIG. 16;

FIG. 19 is a cross-sectional view of the electrical connector taken along a line 19-19 in FIG. 18;

FIG. 20 is a cross-sectional view of the electrical connector in FIG. 18 which is assembled with a cable;

FIG. 21 is a cross-sectional view of the electrical connector taken along a line 21-21 in FIG. 20;

FIG. 22 is an exploded view of an electrical connector according to a fifth embodiment of the disclosure;

FIG. 23 is a cross-sectional view of the electrical connector in FIG. 22;

FIG. 24 is a cross-sectional view of the electrical connector in FIG. 23 which is assembled with a cable;

FIG. 25 is an exploded view of an electrical connector according to a sixth embodiment of the disclosure;

FIG. 26 is a cross-sectional view of the electrical connector in FIG. 25;

FIG. 27 is a cross-sectional view of the electrical connector in FIG. 25 which is assembled with a cable;

FIG. 28 is an exploded view of an electrical connector according to a seventh embodiment of the disclosure;

FIG. 29 is a cross-sectional view of the electrical connector in FIG. 28;

FIG. 30 is a cross-sectional view of the electrical connector in FIG. 28 which is assembled with a cable;

FIG. 31 is a perspective view of an electrical connector according to an eighth embodiment of the disclosure;

FIG. 32 is an exploded view of the electrical connector in FIG. 31;

FIG. 33 is a perspective view of an inner pressing sleeve in FIG. 32;

FIG. 34 is a cross-sectional view of the electrical connector in FIG. 31;

FIGS. 35 and 36 are a cross-sectional view of the electrical connector in FIG. 34 which is assembled with a cable;

FIG. 37 is a perspective view of an electrical connector according to a ninth embodiment of the disclosure;

FIG. 38 is a cross-sectional view of the electrical connector in FIG. 37;

FIGS. 39 and 40 are a cross-sectional view of the electrical connector in FIG. 38 which is assembled with a cable;

FIG. 41 is a perspective view of the electrical connector and the cable in FIG. 40;

FIG. 42 is a cross-sectional view of an electrical connector according to tenth embodiment of the disclosure;

FIG. 43 is a cross-sectional view of the electrical connector in FIG. 42 which is assembled with a cable; and

FIG. 44 is a perspective view of an inner pressing sleeve according to an eleventh embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

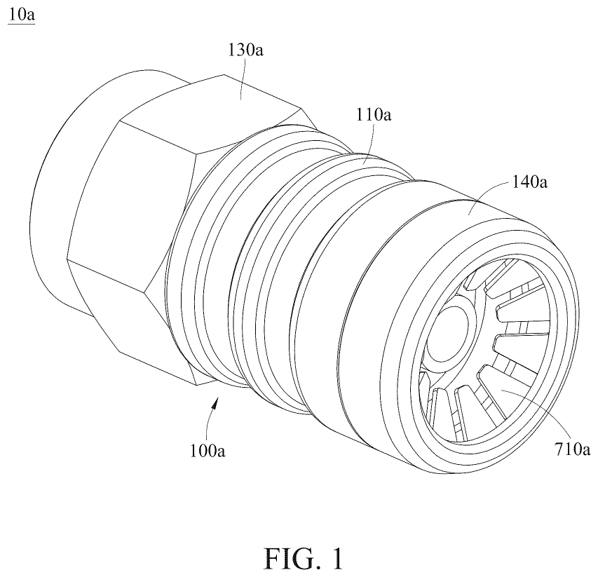

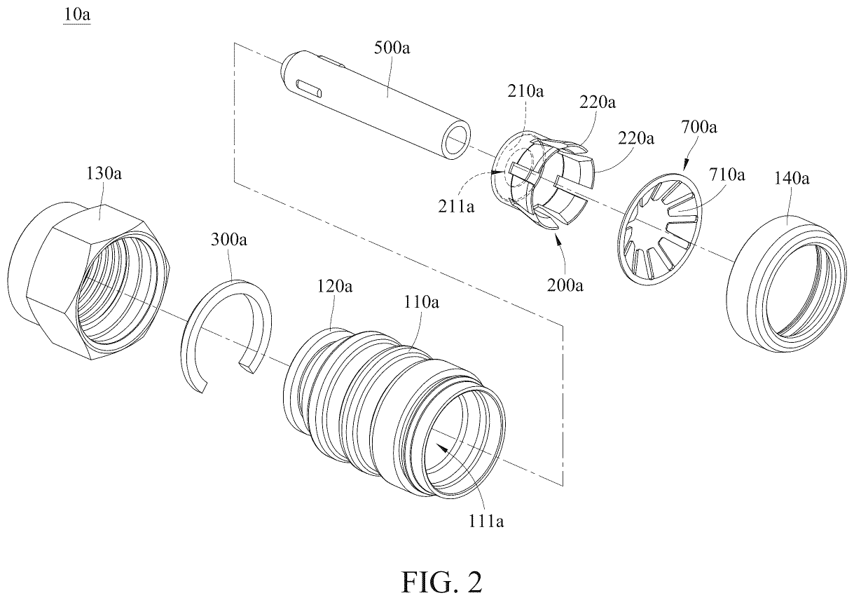

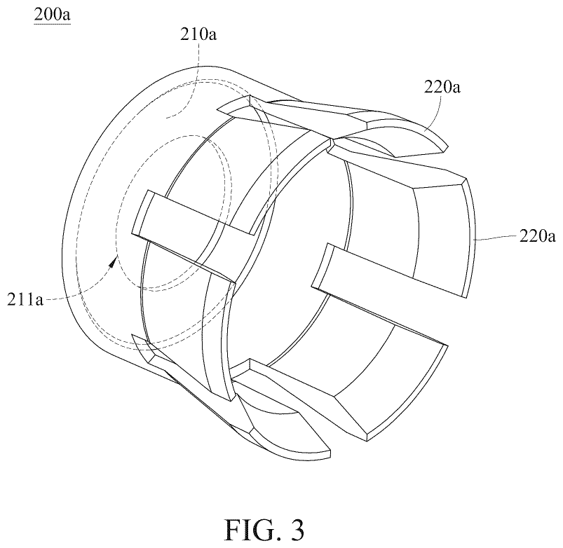

Referring to FIGS. 1 to 3, FIG. 1 is a perspective view of an electrical connector according to a first embodiment of the disclosure, FIG. 2 is an exploded view of the electrical connector in FIG. 1, and FIG. 3 is a perspective view of an inner pressing sleeve in FIG. 2.

In this embodiment, the electrical connector 10a includes a casing 100a and an inner pressing sleeve 200a.

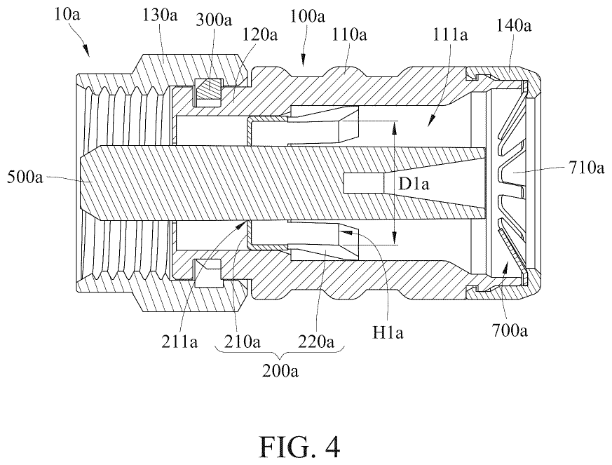

Then, referring to FIGS. 2 and 4, FIG. 4 is a cross-sectional view of the electrical connector in FIG. 1. The casing 100a includes a housing portion 110a and a pressing portion 120a. The housing portion 110a has an installation space 111a, and the pressing portion 120a is at least partially located in the installation space 111a. For example, the pressing portion 120a is integrally formed with the housing portion 110a and extends from the installation space 111a of the housing portion 110a to the outside of the housing portion 110a. The casing 100a may further include a coupling portion 130a, and the electrical connector 10a may further include a positioning component 300a. The coupling portion 130a is rotatably disposed on the part of the pressing portion 120a that is located outside the housing portion 110a via the positioning component 300a. The coupling portion 130a has an inner thread structure, for example, to assemble with a connector of an electronic device (not shown).

It should be noted that the positioning component 300a is an optional component and may be omitted in other embodiments.

As shown in FIGS. 2 to 4, the inner pressing sleeve 200a is slidably located in the installation space 111a, and includes an annular fastening portion 210a and a plurality of elastic clamping portions 220a connected to the annular fastening portion 210a. The elastic clamping portions 220a extend in a same direction from the annular fastening portion 210a and are separated from each other in a circumferential direction of the annular fastening portion 210a. Thicknesses of the elastic clamping portions 220a gradually increases in a direction away from the annular fastening portion 210a. In other embodiments, the thicknesses of the elastic clamping portions 220a may gradually decrease or remain uniform in the direction away from the annular fastening portion 210a.

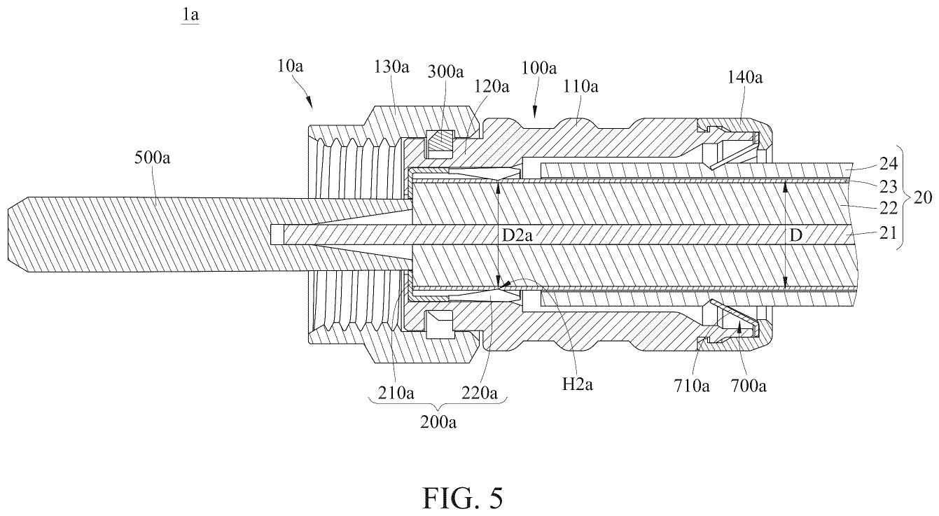

In this embodiment, the electrical connector 10a may further include a guide component 500a. The guide component 500a is made, for example, of an electrically insulating material, such as plastic. The annular fastening portion 210a of the inner pressing sleeve 200a may have a mount hole 211a, and the guide component 500a is movably and removed disposed in the mount hole 211a. The guide component 500a is configured to guide the assembly of a cable 20 (as shown in FIG. 5).

Furthermore, the electrical connector 10a may further include an annular elastic component 700a, and the casing 100a may further include a fastening cover portion 140a. The annular elastic component 700a is mounted at one end of the housing portion 110a via the fastening cover portion 140a, and the annular elastic component 700a is rotatable relative to the housing portion 110a and the fastening cover portion 140a. The annular elastic component 700a has a plurality of elastic arms 710a for stably securing the cable 20. It should be noted that the annular elastic component 700a and the fastening cover portion 140a are optional components and may be omitted in other embodiments.

Then, referring to FIGS. 4 and 5, FIG. 5 is a cross-sectional view of the electrical connector in FIG. 4 which is assembled with a cable. The electrical connector 10a is configured to be assembled with the cable 20, thereby forming a cable assembly 1a together with the cable 20. The cable 20 includes, in order from inside to outside, a conductive core 21, an insulation layer 22, a braided mesh layer 23 (serving as a shielding layer) and an outer layer 24. At one end of the cable 20, the conductive core 21, the insulation layer 22 and the braided mesh layer 23 may be exposed from the outer layer 24.

The following describes the process of assembling the cable 20 to the electrical connector 10a. First, as shown in FIG. 4, when the cable 20 has not yet been inserted into the electrical connector 10a, the inner pressing sleeve 200a is positioned in a non-pressed position, so that the elastic clamping portions 220a of the inner pressing sleeve 200a are not pressed by the pressing portion 120a of the casing 100a. This allows sides of the elastic clamping portions 220a located farther away from the annular fastening portion 210a to form an installation through hole H1a. An inner diameter D1a of the installation through hole H1a is equal to or greater than an outer diameter D of the braided mesh layer 23 of the cable 20.

Next, as shown in FIG. 5, after the cable 20 is inserted into the installation space 111a of the housing portion 110a through a through hole of the fastening cover portion 140a of the casing 100a, the conductive core 21, exposed from the outer layer 24 of the cable 20, is inserted into the guide component 500a. Then, the cable 20, the guide component 500a and the inner pressing sleeve 200a are moved together. Next, the elastic clamping portions 220a of the moving inner pressing sleeve 200a come into contact with the pressing portion 120a of the casing 100a and are temporarily stopped. At this moment, continuing to push the cable 20 causes the cable 20 and the guide component 500a to move relative to the inner pressing sleeve 200a until the cable 20 comes into contact with the annular fastening portion 210a of the inner pressing sleeve 200a through the installation through hole H1a. Then, further pushing the cable 20 forces the inner pressing sleeve 200a to move, causing the elastic clamping portions 220a of the inner pressing sleeve 200a to be pressed by the pressing portion 120a of the casing 100a, thereby forming a clamping hole H2a. In this case, the inner diameter D1a of the installation through hole H1a is greater than an inner diameter D2a of the clamping hole H2a. As a result, the elastic clamping portions 220a of the inner pressing sleeve 200a tightly clamp the braided mesh layer 23 of the cable 20.

In this embodiment, the annular fastening portion 210a of the inner pressing sleeve 200a is slidable relative to the housing portion 110a of the casing 100a, allowing the elastic clamping portions 220a to form the installation through hole H1a when not pressed by the pressing portion 120a of the casing 100a and to form the clamping hole H2a when pressed by the pressing portion 120a, and the inner diameter D1a of the installation through hole H1a is greater than the inner diameter D2a of the clamping hole H2a. This arrangement allows, during the process of inserting the cable 20 into the inner pressing sleeve 200a through the installation space 111a of the housing portion 110a, the elastic clamping portions 220a of the inner pressing sleeve 200a to be pressed by the pressing portion 120a of the casing 100a, thereby tightly clamping the braided mesh layer 23 of the cable 20. In this way, the braided mesh layer 23 of the cable 20 does not need to be folded back, as the elastic clamping portions 220a of the inner pressing sleeve 200a are pressed by the pressing portion 120a of the casing 100a to tightly clamp the braided mesh layer 23 of the cable 20, ensuring an electrical contact between the inner pressing sleeve 200a and the braided mesh layer 23 of the cable 20. Therefore, the step of folding back the braided mesh layer 23 of the cable 20 during the assembly of the cable 20 to the electrical connector 10a is saved, improving the assembly efficiency.

In this embodiment, when the cable assembly 1a is required to be assembled with the connector of the electronic device, the guide component 500a of the electrical connector 10a needs to be removed from the inner pressing sleeve 200a, so that the conductive core 21 of the cable 20 can electrically contact a terminal of the connector of the electronic device. It should be noted that the guide component 500a is an optional component and may be omitted in other practical application examples.

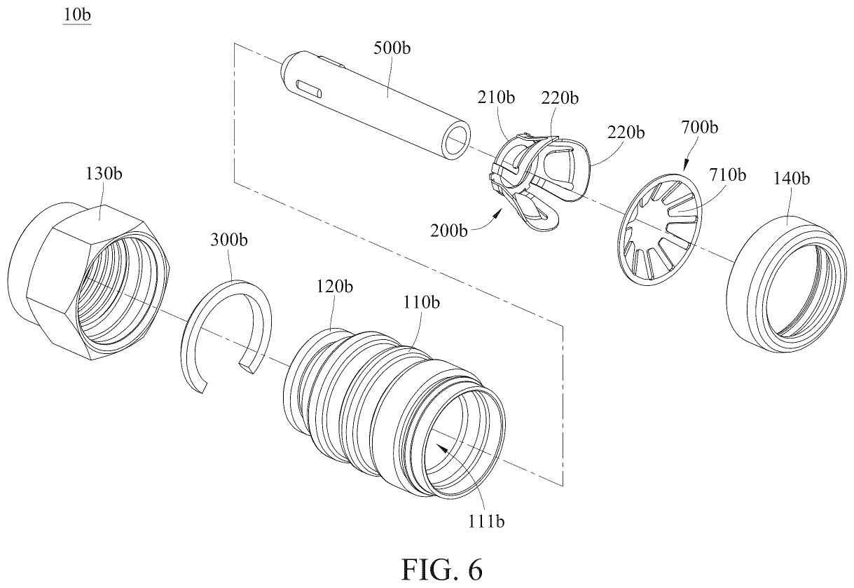

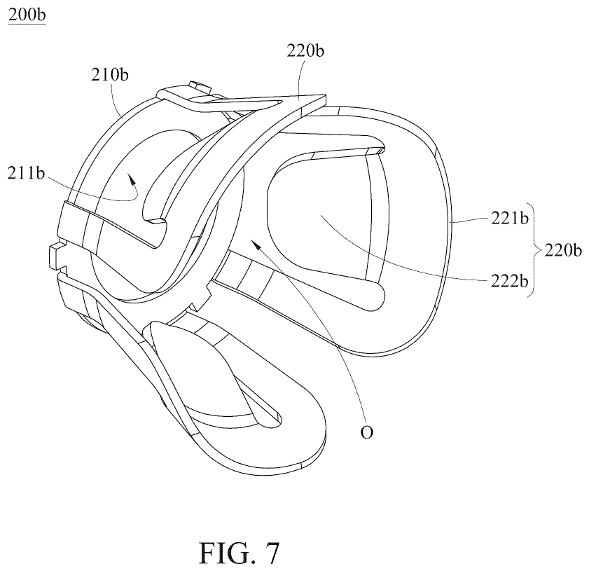

Then, referring to FIGS. 6 and 7, FIG. 6 is an exploded view of an electrical connector according to a second embodiment of the disclosure, and FIG. 7 is a perspective view of an inner pressing sleeve in FIG. 6.

In this embodiment, the electrical connector 10b includes a casing 100b and an inner pressing sleeve 200b.

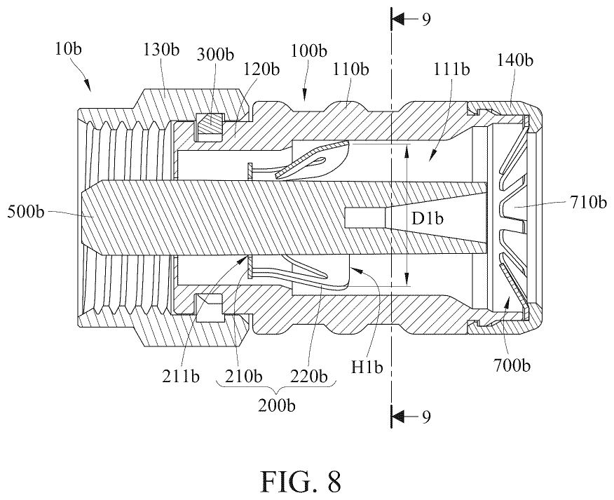

Then, referring to FIGS. 6 and 8, FIG. 8 is a cross-sectional view of the electrical connector in FIG. 6. The casing 100b includes a housing portion 110b and a pressing portion 120b. The housing portion 110b has an installation space 111b, and the pressing portion 120b is at least partially located in the installation space 111b. For example, the pressing portion 120b is integrally formed with the housing portion 110b and extends from the installation space 111b of the housing portion 110b to the outside of the housing portion 110b. The casing 100b may also include a coupling portion 130b, and the electrical connector 10b may further include a positioning component 300b. The coupling portion 130b is rotatably disposed on the part of the pressing portion 120b that is located outside the housing portion 110b via the positioning component 300b. The coupling portion 130b has an inner threaded structure, for example, to assemble with a connector of an electronic device (not shown).

It should be noted that the positioning component 300b is an optional component and may be omitted in other embodiments.

As shown in FIG. 6 to FIG. 8, the inner pressing sleeve 200b is slidably located in the installation space 111b and includes an annular fastening portion 210b and a plurality of elastic clamping portions 220b connected to the annular fastening portion 210b. The elastic clamping portions 220b extend in a same direction from the annular fastening portion 210b and are spaced apart from each other in a circumferential direction of the annular fastening portion 210b. Each of the elastic clamping portions 220b includes a peripheral part 221b and an inner arm part 222b. In one elastic clamping portion 220b, two ends of the peripheral part 221b are connected to the annular fastening portion 210b, the peripheral part 221b and the annular fastening portion 210b together form an opening O, and the inner arm part 222b is connected to the peripheral part 221b and located in the opening O. In other embodiments, the inner arm part 222b may be directly connected to the annular fastening portion 210b.

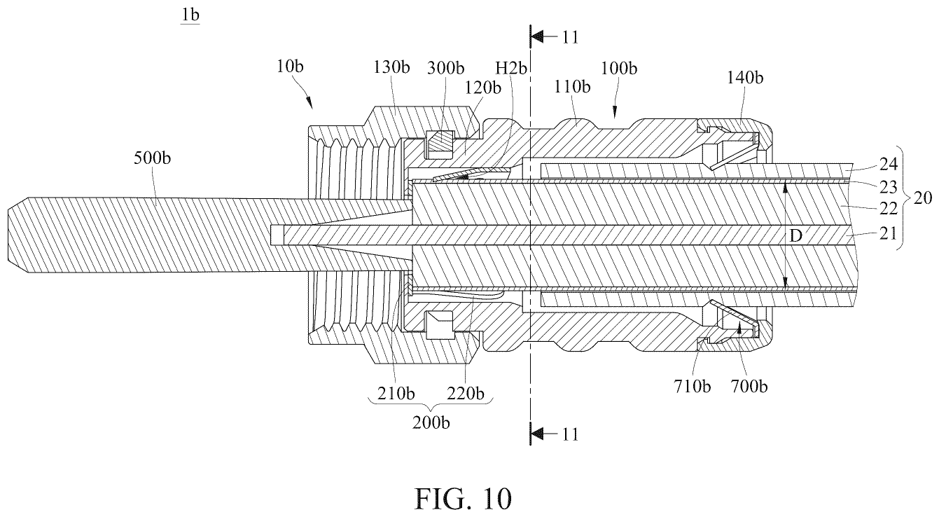

In this embodiment, the electrical connector 10b may further include a guide component 500b. The guide component 500b is made of an electrically insulating material, such as plastic. The annular fastening portion 210b of the inner pressing sleeve 200b may have a mount hole 211b, and the guide component 500b is movably and removably disposed in the mount hole 211b. The guide component 500b is configured to guide the assembly of a cable 20 (as shown in FIG. 10).

In addition, the electrical connector 10b may further include an annular elastic component 700b, and the casing 100b may further include a fastening cover portion 140b. The annular elastic component 700b is mounted at one end of the housing portion 110b via the fastening cover portion 140b, and the annular elastic component 700b is rotatable relative to the housing portion 110b and the fastening cover portion 140b. The annular elastic component 700b has a plurality of elastic arms 710b for stably securing the cable 20. It should be noted that the annular elastic component 700b and the fastening cover portion 140b are optional components and may be omitted in other embodiments.

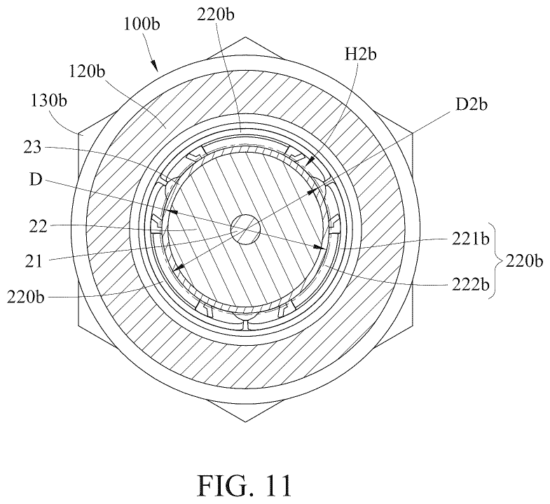

Then, referring to FIGS. 8 to 11, FIG. 9 is a cross-sectional view of the electrical connector taken along a line 9-9 in FIG. 8, FIG. 10 is a cross-sectional view of the electrical connector in FIG. 8 which is assembled with a cable, and FIG. 11 is a cross-sectional view of the electrical connector taken along a line 11-11 in FIG. 10.

The electrical connector 10b is configured to be assembled with the cable 20, thereby forming a cable assembly 1b together with the cable 20. The cable 20 includes, in order from inside to outside, a conductive core 21, an insulation layer 22, a braided mesh layer 23 (serving as a shielding layer), and an outer layer 24. At one end of the cable 20, the conductive core 21, the insulation layer 22 and the braided mesh layer 23 may be exposed from the outer layer 24.

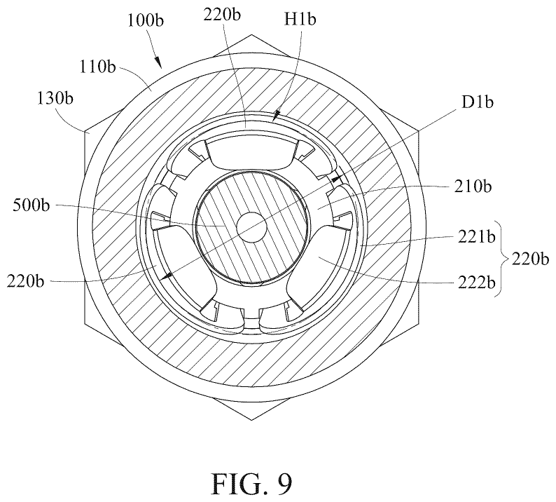

The following describes the process of assembling the cable 20 to the electrical connector 10b. First, as shown in FIGS. 8 and 9, when the cable 20 has not yet been inserted into the electrical connector 10b, the inner pressing sleeve 200b is in a non-pressed position, such that the elastic clamping portions 220b of the inner pressing sleeve 200b are not pressed by the pressing portion 120b of the casing 100b. This allows an installation through hole H1b to be formed on sides of the elastic clamping portions 220b located farther away from the annular fastening portion 210b. An inner diameter D1b of the installation through hole H1b (referring to the maximum inner diameter) is equal to or greater than an outer diameter D of the braided mesh layer 23 of the cable 20.

Next, as shown in FIGS. 10 and 11, after the cable 20 is inserted into the installation space 111b of the housing portion 110b through a through hole of the fastening cover portion 140b of the casing 100b, the conductive core 21 exposed outside the outer layer 24 of the cable 20 is inserted into the guide component 500b. Then, the cable 20, the guide component 500b, and the inner pressing sleeve 200b are moved together. As the inner pressing sleeve 200b moves, the elastic clamping portions 220b come into contact with the pressing portion 120b of the casing 100b and are temporarily stopped. At this moment, continuing to push the cable 20 causes the cable 20 and the guide component 500b to move relative to the inner pressing sleeve 200b until the cable 20 passes through the installation through hole H1b and contacts the annular fastening portion 210b of the inner pressing sleeve 200b. During this process, the inner arm parts 222b of the elastic clamping portions 220b of the inner pressing sleeve 200b are expanded outward by the braided mesh layer 23 of the cable 20. Then, as the cable 20 continues to be pushed, it forces the inner pressing sleeve 200b to move, causing the peripheral parts 221b of the elastic clamping portions 220b to be pressed inward by the pressing portion 120b of the casing 100b, thereby forming a clamping hole H2b at the inner arm parts 222b of the elastic clamping portions 220b. The inner diameter D1b of the installation through hole H1b is larger than an inner diameter D2b of the clamping hole H2b. In this way, the elastic clamping portions 220b of the inner pressing sleeve 200b tightly clamp the braided mesh layer 23 of the cable 20.

In this embodiment, the annular fastening portion 210b of the inner pressing sleeve 200b is slidable relative to the housing portion 110b of the casing 100b, allowing the elastic clamping portions 220b to form the installation through hole H1b when not pressed by the pressing portion 120b of the casing 100b and to form the clamping hole H2b when pressed by the pressing portion 120b, and the inner diameter D1b of the installation through hole H1b is greater than the inner diameter D2b of the clamping hole H2b. This arrangement allows, during the process of inserting the cable 20 into the inner pressing sleeve 200b through the installation space 111b of the housing portion 110b, the elastic clamping portions 220b of the inner pressing sleeve 200b to be pressed by the pressing portion 120b of the casing 100b, thereby tightly clamping the braided mesh layer 23 of the cable 20. In this way, the braided mesh layer 23 of the cable 20 does not need to be folded back, as the elastic clamping portions 220b of the inner pressing sleeve 200b are pressed by the pressing portion 120b of the casing 100b to tightly clamp the braided mesh layer 23 of the cable 20, ensuring an electrical contact between the inner pressing sleeve 200b and the braided mesh layer 23 of the cable 20. Therefore, the step of folding back the braided mesh layer 23 of the cable 20 during the assembly process of the cable 20 to the electrical connector 10b is saved, thereby improving assembly efficiency.

In this embodiment, when the cable assembly 1b is required to be assembled with the connector of the electronic device, the guide component 500b of the electrical connector 10b needs to be removed from the inner pressing sleeve 200b, so that the conductive core 21 of the cable 20 can electrically contact a terminal of the connector of the electronic device. It should be noted that the guide component 500b is an optional component and may be omitted in other practical application examples.

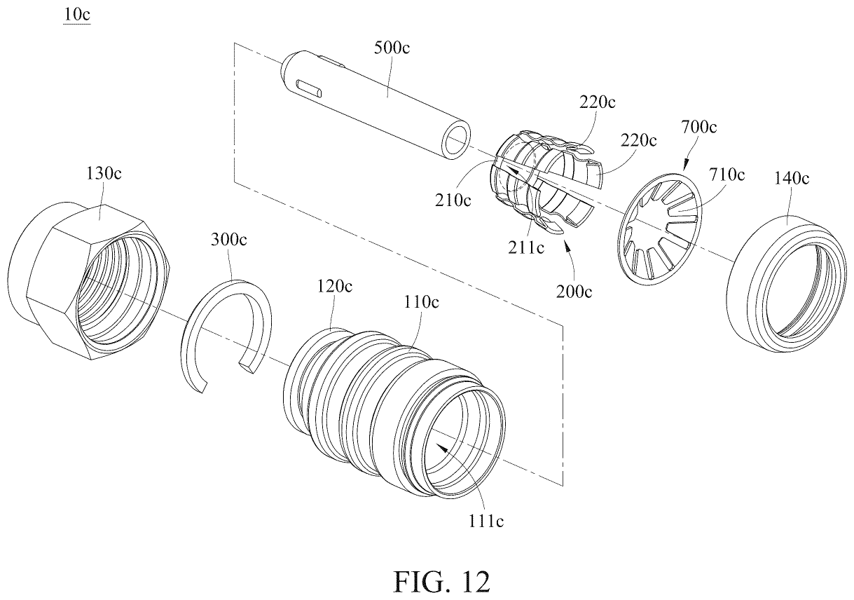

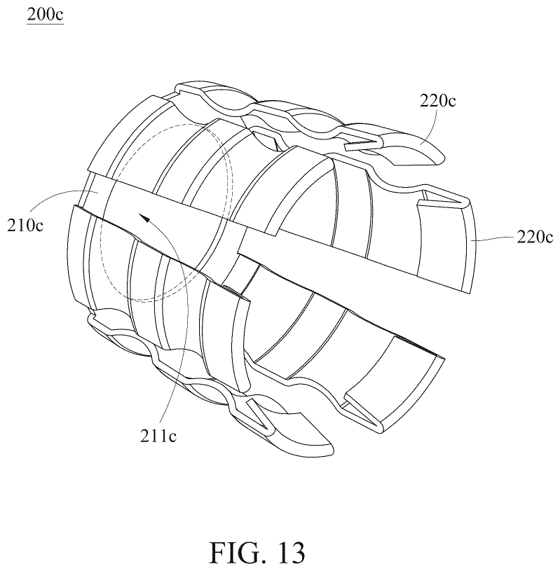

Then, referring to FIGS. 12 and 13, FIG. 12 is an exploded view of an electrical connector according to a third embodiment of the disclosure, and FIG. 13 is a perspective view of an inner pressing sleeve in FIG. 12.

In this embodiment, the electrical connector 10c includes a casing 100c and an inner pressing sleeve 200c.

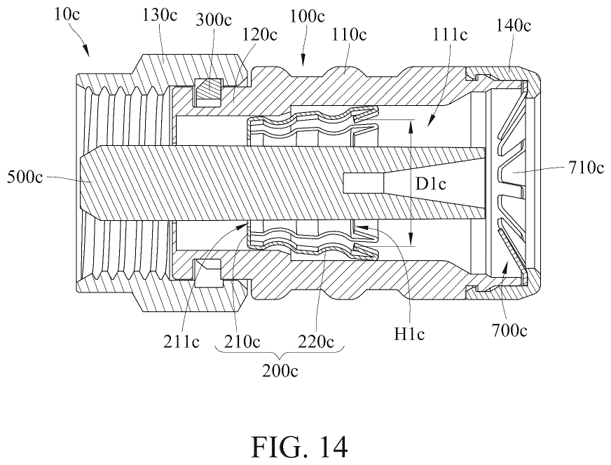

Then, referring to FIGS. 12 and 14, FIG. 14 is a cross-sectional view of the electrical connector in FIG. 12.

The casing 100c includes a housing portion 110c and a pressing portion 120c. The housing portion 110c has an installation space 111c, and the pressing portion 120c is at least partially located in the installation space 111c. For example, the pressing portion 120c is integrally formed with the housing portion 110c and extends from the installation space 111c of the housing portion 110c to the outside of the housing portion 110c. The casing 100c may further include a coupling portion 130c, and the electrical connector 10c may further include a positioning component 300c. The coupling portion 130c is rotatably disposed on the part of the pressing portion 120c that is located outside the housing portion 110c via the positioning component 300c. The coupling portion 130c has an inner thread structure, for example, to assemble with a connector of an electronic device (not shown).

It should be noted that the positioning component 300c is an optional component and may be omitted in other embodiments.

As shown in FIGS. 12 to 14, the inner pressing sleeve 200c is slidably located in the installation space 111c, and includes an annular fastening portion 210c and a plurality of elastic clamping portions 220c connected to the annular fastening portion 210c. The elastic clamping portions 220c extend in a same direction from the annular fastening portion 210c and are separated from each other in a circumferential direction of the annular fastening portion 210c. The elastic clamping portions 220c are in a wavy shape.

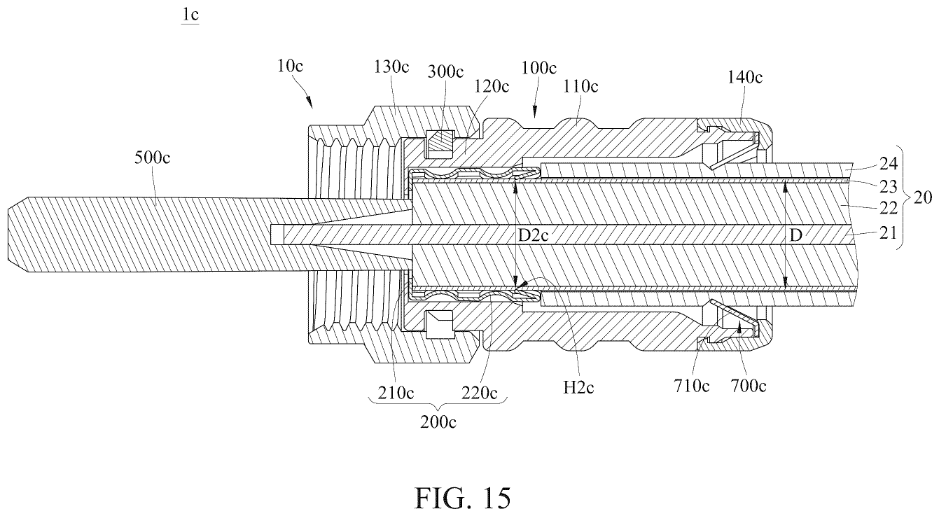

In this embodiment, the electrical connector 10c may further include a guide component 500c. The guide component 500c is made, for example, of an electrically insulating material, such as plastic. The annular fastening portion 210c of the inner pressing sleeve 200c may have a mount hole 211c, and the guide component 500c is movably and removed disposed in the mount hole 211c. The guide component 500c is configured to guide the assembly of a cable 20 (as shown in FIG. 15).

Furthermore, the electrical connector 10c may further include an annular elastic component 700c, and the casing 100c may further include a fastening cover portion 140c. The annular elastic component 700c is mounted at one end of the housing portion 110c via the fastening cover portion 140c, and the annular elastic component 700c is rotatable relative to the housing portion 110c and the fastening cover portion 140c. The annular elastic component 700c has a plurality of elastic arms 710c for stably securing the cable 20. It should be noted that the annular elastic component 700c and the fastening cover portion 140c are optional components and may be omitted in other embodiments.

Then, referring to FIGS. 14 and 15, FIG. 15 is a cross-sectional view of the electrical connector in FIG. 12 which is assembled with a cable. The electrical connector 10c is configured to be assembled with the cable 20, thereby forming a cable assembly 1c together with the cable 20. The cable 20 includes, in order from inside to outside, a conductive core 21, an insulation layer 22, a braided mesh layer 23 (serving as a shielding layer) and an outer layer 24. At one end of the cable 20, the conductive core 21, the insulation layer 22 and the braided mesh layer 23 may be exposed from the outer layer 24.

The following describes the process of assembling the cable 20 to the electrical connector 10c. First, as shown in FIG. 14, when the cable 20 has not yet been inserted into the electrical connector 10c, the inner pressing sleeve 200c is positioned in a non-pressed position, so that the elastic clamping portions 220c of the inner pressing sleeve 200c are not pressed by the pressing portion 120c of the casing 100c. This allows sides of the elastic clamping portions 220c located farther away from the annular fastening portion 210c to form an installation through hole H1c. An inner diameter D1c of the installation through hole H1c is equal to or greater than an outer diameter D of the braided mesh layer 23 of the cable 20.

Next, as shown in FIG. 15, after the cable 20 is inserted into the installation space 111c of the housing portion 110c through a through hole of the fastening cover portion 140c of the casing 100c, the conductive core 21, exposed from the outer layer 24 of the cable 20, is inserted into the guide component 500c. Then, the cable 20, the guide component 500c and the inner pressing sleeve 200c are moved together. Next, the elastic clamping portions 220c of the moving inner pressing sleeve 200c come into contact with the pressing portion 120c of the casing 100c and are temporarily stopped. At this moment, continuing to push the cable 20 causes the cable 20 and the guide component 500c to move relative to the inner pressing sleeve 200c until the cable 20 comes into contact with the annular fastening portion 210c of the inner pressing sleeve 200c through the installation through hole H1c. Then, further pushing the cable 20 forces the inner pressing sleeve 200c to move, causing the elastic clamping portions 220c of the inner pressing sleeve 200c to be pressed by the pressing portion 120c of the casing 100c, thereby forming a clamping hole H2c. In this case, the inner diameter D1c of the installation through hole H1c is greater than an inner diameter D2c of the clamping hole H2c. As a result, the elastic clamping portions 220c of the inner pressing sleeve 200c tightly clamp the braided mesh layer 23 of the cable 20.

In this embodiment, the annular fastening portion 210c of the inner pressing sleeve 200c is slidable relative to the housing portion 110c of the casing 100c, allowing the elastic clamping portions 220c to form the installation through hole H1c when not pressed by the pressing portion 120c of the casing 100c and to form the clamping hole H2c when pressed by the pressing portion 120c, and the inner diameter D1c of the installation through hole H1c is greater than the inner diameter D2c of the clamping hole H2c. This arrangement allows, during the process of inserting the cable 20 into the inner pressing sleeve 200c through the installation space 111c of the housing portion 110c, the elastic clamping portions 220c of the inner pressing sleeve 200c to be pressed by the pressing portion 120c of the casing 100c, thereby tightly clamping the braided mesh layer 23 of the cable 20. In this way, the braided mesh layer 23 of the cable 20 does not need to be folded back, as the elastic clamping portions 220c of the inner pressing sleeve 200c are pressed by the pressing portion 120c of the casing 100c to tightly clamp the braided mesh layer 23 of the cable 20, ensuring an electrical contact between the inner pressing sleeve 200c and the braided mesh layer 23 of the cable 20. Therefore, the step of folding back the braided mesh layer 23 of the cable 20 during the assembly of the cable 20 to the electrical connector 10c is saved, improving the assembly efficiency.

In this embodiment, when the cable assembly 1c is required to be assembled with the connector of the electronic device, the guide component 500c of the electrical connector 10c needs to be removed from the inner pressing sleeve 200c, so that the conductive core 21 of the cable 20 can electrically contact a terminal of the connector of the electronic device. It should be noted that the guide component 500c is an optional component and may be omitted in other practical application examples.

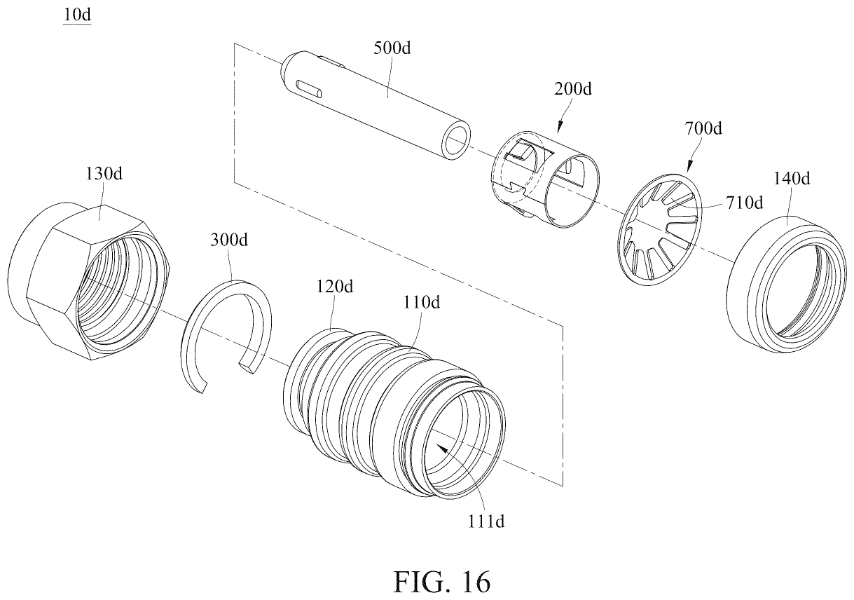

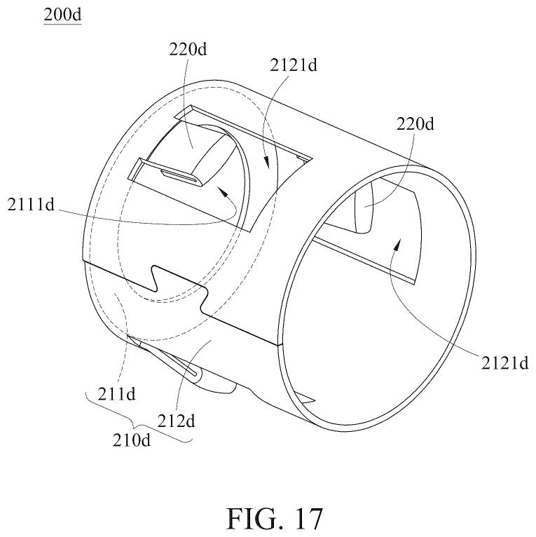

Then, referring to FIGS. 16 and 17, FIG. 16 is an exploded view of an electrical connector according to a fourth embodiment of the disclosure, and FIG. 17 is a perspective view of an inner pressing sleeve in FIG. 16.

In this embodiment, the electrical connector 10d includes a casing 100d and an inner pressing sleeve 200d.

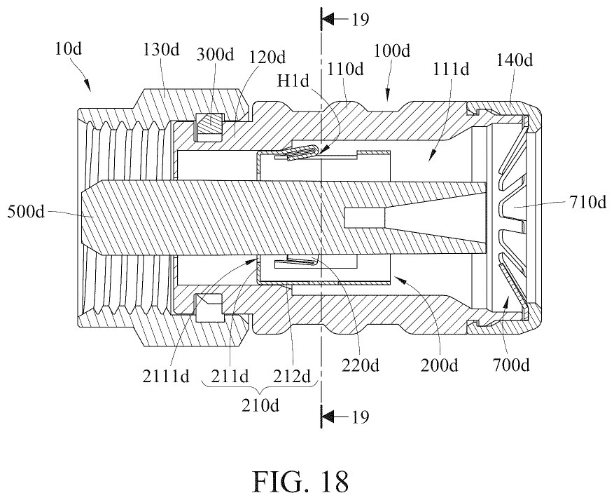

Then, referring to FIGS. 16 and 18, FIG. 18 is a cross-sectional view of the electrical connector in FIG. 16. The casing 100d includes a housing portion 110d and a pressing portion 120d. The housing portion 110d has an installation space 111d, and the pressing portion 120d is at least partially located in the installation space 111d. For example, the pressing portion 120d is integrally formed with the housing portion 110d and extends from the installation space 111d of the housing portion 110d to the outside of the housing portion 110d. The casing 100d may also include a coupling portion 130d, and the electrical connector 10d may further include a positioning component 300d. The coupling portion 130d is rotatably disposed on the part of the pressing portion 120d that is located outside the housing portion 110d via the positioning component 300d. The coupling portion 130d has an inner threaded structure, for example, to assembled with a connector of an electronic device (not shown).

It should be noted that the positioning component 300d is an optional component and may be omitted in other embodiments.

As shown in FIG. 16 to FIG. 18, the inner pressing sleeve 200d is slidably located in the installation space 111d and includes an annular fastening portion 210d and a plurality of elastic clamping portions 220d connected to the annular fastening portion 210d. The annular fastening portion 210d includes a base 211d and an annular wall 212d. The annular wall 212d is connected to a periphery of the base 211d. The annular wall 212d has a plurality of openings 2121d, and the openings 2121d are spaced apart from one other in a circumferential direction of the annular wall 212d. The elastic clamping portions 220d are connected to the annular wall 212d and are respectively located in the openings 2121d. Depending on the actual design, each of the elastic clamping portions 220d may be connected to any side of the opening 2121d of the annular wall 212d.

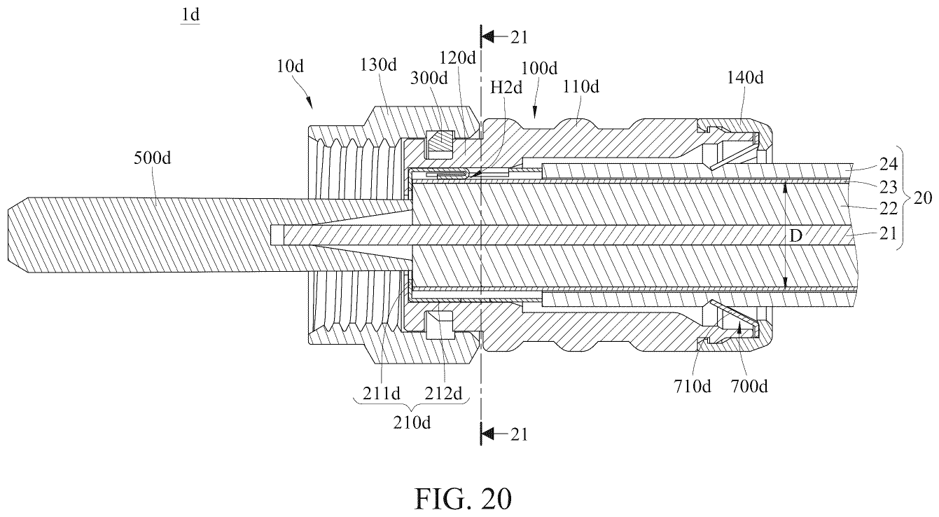

In this embodiment, the electrical connector 10d may further include a guide component 500d. The guide component 500d is made of an electrically insulating material, such as plastic. The base 211d of the annular fastening portion 210d of the inner pressing sleeve 200d may have a mount hole 2111d, and the guide component 500d is movably and removably disposed in the mount hole 2111d. The guide component 500d is configured to guide the assembly of a cable 20 (as shown in FIG. 20).

In addition, the electrical connector 10d may further include an annular elastic component 700d, and the casing 100d may further include a fastening cover portion 140d. The annular elastic component 700d is mounted at one end of the housing portion 110d via the fastening cover portion 140d, and the annular elastic component 700d is rotatable relative to the housing portion 110d and the fastening cover portion 140d. The annular elastic component 700d has a plurality of elastic arms 710d for stably securing the cable 20. It should be noted that the annular elastic component 700d and the fastening cover portion 140d are optional components and may be omitted in other embodiments.

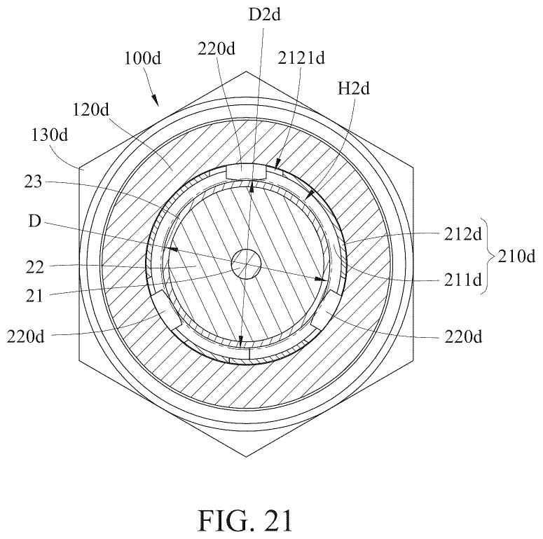

Then, referring to FIGS. 18 to 21, FIG. 19 is a cross-sectional view of the electrical connector taken along a line 19-19 in FIG. 18, FIG. 20 is a cross-sectional view of the electrical connector in FIG. 18 which is assembled with a cable, and FIG. 21 is a cross-sectional view of the electrical connector taken along a line 21-21 in FIG. 20.

The electrical connector 10d is configured to be assembled with the cable 20, thereby forming a cable assembly 1d together with the cable 20. The cable 20 includes, in order from inside to outside, a conductive core 21, an insulation layer 22, a braided mesh layer 23 (serving as a shielding layer), and an outer layer 24. At one end of the cable 20, the conductive core 21, the insulation layer 22 and the braided mesh layer 23 may be exposed from the outer layer 24.

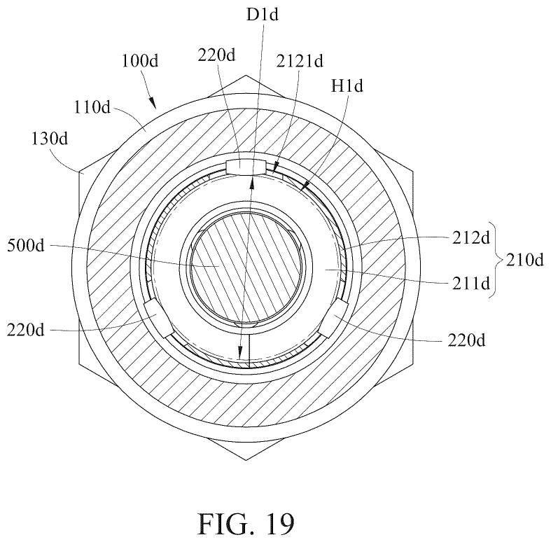

The following describes the process of assembling the cable 20 to the electrical connector 10d. First, as shown in FIGS. 18 and 19, when the cable 20 has not yet been inserted into the electrical connector 10d, the inner pressing sleeve 200d is positioned in a non-pressed position, so that the elastic clamping portions 220d of the inner pressing sleeve 200d are not pressed by the pressing portion 120d of the casing 100d. This allows sides of the elastic clamping portions 220d located farther away from the base 211d to form an installation through hole H1d. An inner diameter D1d of the installation through hole H1d is equal to or greater than an outer diameter D of the braided mesh layer 23 of the cable 20.

Next, as shown in FIGS. 20 and 21, after the cable 20 is inserted into the installation space 111d of the housing portion 110d through a through hole of the fastening cover portion 140d of the casing 100d, the conductive core 21, exposed from the outer layer 24 of the cable 20, is inserted into the guide component 500d. Then, the cable 20, the guide component 500d and the inner pressing sleeve 200d are moved together. Next, the elastic clamping portions 220d of the moving inner pressing sleeve 200d come into contact with the pressing portion 120d of the casing 100d and are temporarily stopped. At this moment, continuing to push the cable 20 causes the cable 20 and the guide component 500d to move relative to the inner pressing sleeve 200d until the cable 20 comes into contact with the base 211d of the annular fastening portion 210d of the inner pressing sleeve 200d through the installation through hole H1d. Then, further pushing the cable 20 forces the inner pressing sleeve 200d to move, causing the elastic clamping portions 220d of the inner pressing sleeve 200d to be pressed by the pressing portion 120d of the casing 100d, thereby forming a clamping hole H2d at sides of the elastic clamping portions 220d located farther away from the base 211d. In this case, the inner diameter D1d of the installation through hole H1d is greater than an inner diameter D2d of the clamping hole H2d. As a result, the elastic clamping portions 220d of the inner pressing sleeve 200d tightly clamp the braided mesh layer 23 of the cable 20.

In this embodiment, the annular fastening portion 210d of the inner pressing sleeve 200d is slidable relative to the housing portion 110d of the casing 100d, allowing the elastic clamping portions 220d to form the installation through hole H1d when not pressed by the pressing portion 120d of the casing 100d and to form the clamping hole H2d when pressed by the pressing portion 120d, and the inner diameter D1d of the installation through hole H1d is greater than the inner diameter D2d of the clamping hole H2d. This arrangement allows, during the process of inserting the cable 20 into the inner pressing sleeve 200d through the installation space 111d of the housing portion 110d, the elastic clamping portions 220d of the inner pressing sleeve 200d to be pressed by the pressing portion 120d of the casing 100d, thereby tightly clamping the braided mesh layer 23 of the cable 20. In this way, the braided mesh layer 23 of the cable 20 does not need to be folded back, as the elastic clamping portions 220d of the inner pressing sleeve 200d are pressed by the pressing portion 120d of the casing 100d to tightly clamp the braided mesh layer 23 of the cable 20, ensuring an electrical contact between the inner pressing sleeve 200d and the braided mesh layer 23 of the cable 20. Therefore, the step of folding back the braided mesh layer 23 of the cable 20 during the assembly of the cable 20 to the electrical connector 10d is saved, improving the assembly efficiency.

In this embodiment, when the cable assembly 1d is required to be assembled with the connector of the electronic device, the guide component 500d of the electrical connector 10d needs to be removed from the inner pressing sleeve 200d, so that the conductive core 21 of the cable 20 can electrically contact a terminal of the connector of the electronic device. It should be noted that the guide component 500d is an optional component and may be omitted in other practical application examples.

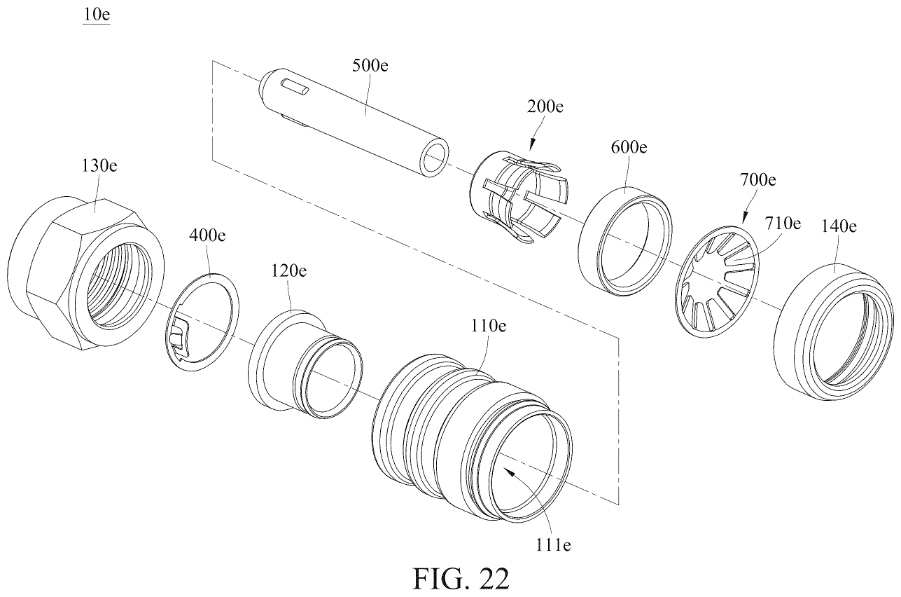

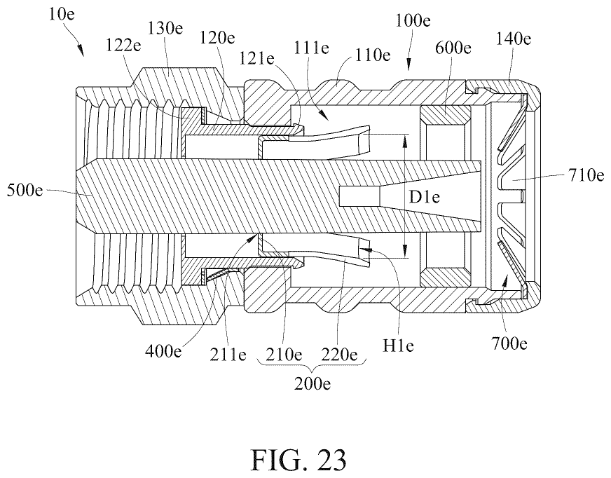

Then, referring to FIGS. 22 and 23, FIG. 22 is an exploded view of an electrical connector according to a fifth embodiment of the disclosure, and FIG. 23 is a cross-sectional view of the electrical connector in FIG. 22.

In this embodiment, the electrical connector 10e includes a casing 100e and an inner pressing sleeve 200e.

The casing 100e includes a housing portion 110e and a pressing portion 120e. The housing portion 110e has an installation space 111e, and the pressing portion 120e is at least partially located in the installation space 111e. For example, the pressing portion 120e and the housing portion 110e are made of two pieces, and the pressing portion 120e extends from the installation space 111e of the housing portion 110e to the outside of the housing portion 110e. The pressing portion 120e has an outwardly bent edge 121e at one end thereof located in the installation space 111e, and the pressing portion 120e has a flange 122e at one end thereof located outside the installation space 111e. The casing 100e may further include a coupling portion 130e. The coupling portion 130e is rotatably disposed on the part of the pressing portion 120e that is located outside the housing portion 110e, and a part of the coupling portion 130e and a part of the housing portion 110e are clamped by the outwardly bent edge 121e and the flange 122e of the pressing portion 120e. The coupling portion 130e has an inner thread structure, for example, to assemble with a connector of an electronic device (not shown).

In this embodiment, the electrical connector 10e may further include an elastic sheet 400e. The elastic sheet 400e is disposed between the coupling portion 130e and the pressing portion 120e to stably secure the coupling portion 130e to the pressing portion 120e.

It should be noted that the elastic sheet 400e is an optional component and may be omitted in other embodiments.

The inner pressing sleeve 200e is slidably located in the installation space 111e, and includes an annular fastening portion 210e and a plurality of elastic clamping portions 220e connected to the annular fastening portion 210e. The elastic clamping portions 220e extend in a same direction from the annular fastening portion 210e and are separated from each other in a circumferential direction of the annular fastening portion 210e. Thicknesses of the elastic clamping portions 220e gradually increases in a direction away from the annular fastening portion 210e. In other embodiments, the thicknesses of the elastic clamping portions 220e may gradually decrease or remain uniform in the direction away from the annular fastening portion 210e.

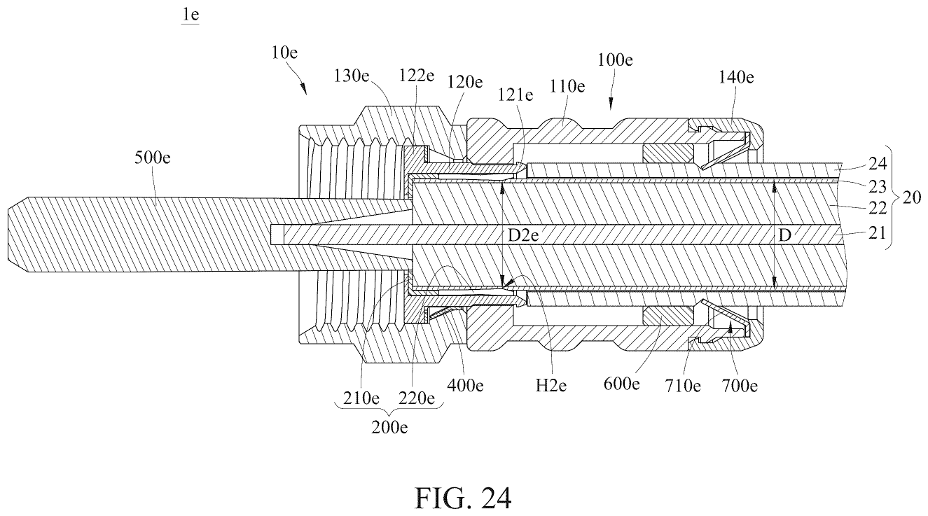

In this embodiment, the electrical connector 10e may further include a guide component 500e. The guide component 500e is made, for example, of an electrically insulating material, such as plastic. The annular fastening portion 210e of the inner pressing sleeve 200e may have a mount hole 211e, and the guide component 500e is movably and removed disposed in the mount hole 211e. The guide component 500e is configured to guide the assembly of a cable 20 (as shown in FIG. 24).

Furthermore, the electrical connector 10e may further include an annular elastic component 700e, and the casing 100e may further include a fastening cover portion 140e. The annular elastic component 700e is mounted at one end of the housing portion 110e via the fastening cover portion 140e, and the annular elastic component 700e is rotatable relative to the housing portion 110e and the fastening cover portion 140e. The annular elastic component 700e has a plurality of elastic arms 710e for stably securing the cable 20. It should be noted that the annular elastic component 700e and the fastening cover portion 140e are optional components and may be omitted in other embodiments.

Moreover, the electrical connector 10e may further include a fastening ring 600e. The fastening ring 600e is disposed in the installation space 111e for stably securing the cable 20. It should be noted that the fastening ring 600e is an optional component and may be omitted in other embodiments.

Then, referring to FIGS. 23 and 24, FIG. 24 is a cross-sectional view of the electrical connector in FIG. 23 which is assembled with a cable. The electrical connector 10e is configured to be assembled with the cable 20, thereby forming a cable assembly 1e together with the cable 20. The cable 20 includes, in order from inside to outside, a conductive core 21, an insulation layer 22, a braided mesh layer 23 (serving as a shielding layer) and an outer layer 24. At one end of the cable 20, the conductive core 21, the insulation layer 22 and the braided mesh layer 23 may be exposed from the outer layer 24.

The following describes the process of assembling the cable 20 to the electrical connector 10e. First, as shown in FIG. 23, when the cable 20 has not yet been inserted into the electrical connector 10e, the inner pressing sleeve 200e is positioned in a non-pressed position, so that the elastic clamping portions 220e of the inner pressing sleeve 200e are not pressed by the pressing portion 120e of the casing 100e. This allows sides of the elastic clamping portions 220e located farther away from the annular fastening portion 210e to form an installation through hole H1e. An inner diameter D1e of the installation through hole H1e is equal to or greater than an outer diameter D of the braided mesh layer 23 of the cable 20.

Next, as shown in FIG. 24, after the cable 20 is inserted into the installation space 111e of the housing portion 110e through a through hole of the fastening cover portion 140e of the casing 100e, the conductive core 21, exposed from the outer layer 24 of the cable 20, is inserted into the guide component 500e. Then, the cable 20, the guide component 500e and the inner pressing sleeve 200e are moved together. Next, the elastic clamping portions 220e of the moving inner pressing sleeve 200e come into contact with the pressing portion 120e of the casing 100e and are temporarily stopped. At this moment, continuing to push the cable 20 causes the cable 20 and the guide component 500e to move relative to the inner pressing sleeve 200e until the cable 20 comes into contact with the annular fastening portion 210e of the inner pressing sleeve 200e through the installation through hole H1e. Then, further pushing the cable 20 forces the inner pressing sleeve 200e to move, causing the elastic clamping portions 220e of the inner pressing sleeve 200e to be pressed by the pressing portion 120e of the casing 100e, thereby forming a clamping hole H2e. In this case, the inner diameter D1e of the installation through hole H1e is greater than an inner diameter D2e of the clamping hole H2e. As a result, the elastic clamping portions 220e of the inner pressing sleeve 200e tightly clamp the braided mesh layer 23 of the cable 20.

In this embodiment, the annular fastening portion 210e of the inner pressing sleeve 200e is slidable relative to the housing portion 110e of the casing 100e, allowing the elastic clamping portions 220e to form the installation through hole H1e when not pressed by the pressing portion 120e of the casing 100e and to form the clamping hole H2e when pressed by the pressing portion 120e, and the inner diameter D1e of the installation through hole H1e is greater than the inner diameter D2e of the clamping hole H2e. This arrangement allows, during the process of inserting the cable 20 into the inner pressing sleeve 200e through the installation space 111e of the housing portion 110e, the elastic clamping portions 220e of the inner pressing sleeve 200e to be pressed by the pressing portion 120e of the casing 100e, thereby tightly clamping the braided mesh layer 23 of the cable 20. In this way, the braided mesh layer 23 of the cable 20 does not need to be folded back, as the elastic clamping portions 220e of the inner pressing sleeve 200e are pressed by the pressing portion 120e of the casing 100e to tightly clamp the braided mesh layer 23 of the cable 20, ensuring an electrical contact between the inner pressing sleeve 200e and the braided mesh layer 23 of the cable 20. Therefore, the step of folding back the braided mesh layer 23 of the cable 20 during the assembly of the cable 20 to the electrical connector 10e is saved, improving the assembly efficiency.

In this embodiment, when the cable assembly 1e is required to be assembled with the connector of the electronic device, the guide component 500e of the electrical connector 10e needs to be removed from the inner pressing sleeve 200e, so that the conductive core 21 of the cable 20 can electrically contact a terminal of the connector of the electronic device. It should be noted that the guide component 500e is an optional component and may be omitted in other practical application examples.

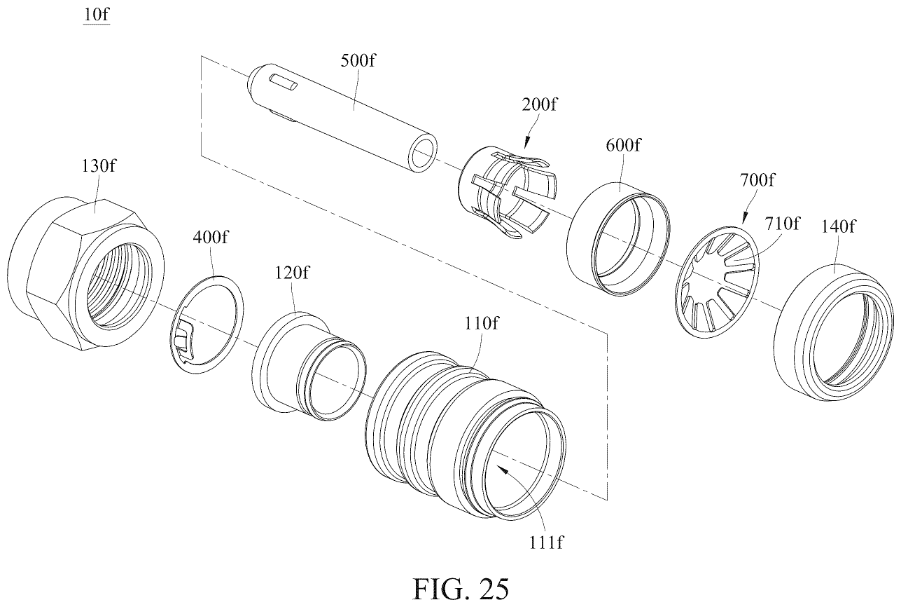

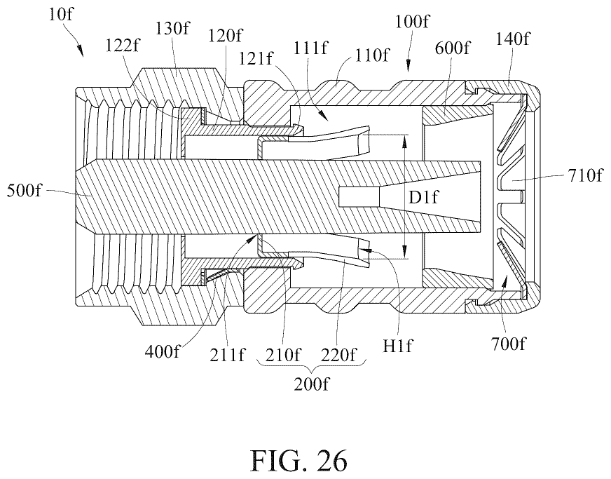

Then, referring to FIGS. 25 and 26, FIG. 25 is an exploded view of an electrical connector according to a sixth embodiment of the disclosure, and FIG. 26 is a cross-sectional view of the electrical connector in FIG. 25.

In this embodiment, the electrical connector 10f includes a casing 100f and an inner pressing sleeve 200f.

The casing 100f includes a housing portion 110f and a pressing portion 120f. The housing portion 110f has an installation space 111f, and the pressing portion 120f is at least partially located in the installation space 111f. For example, the pressing portion 120f and the housing portion 110f are made of two pieces, and the pressing portion 120f extends from the installation space 111f of the housing portion 110f to the outside of the housing portion 110f. The pressing portion 120f has an outwardly bent edge 121f at one end thereof located in the installation space 111f, and the pressing portion 120f has a flange 122f at one end thereof located outside the installation space 111f. The casing 100f may further include a coupling portion 130f. The coupling portion 130f is rotatably disposed on the part of the pressing portion 120f that is located outside the housing portion 110f, and a part of the coupling portion 130f and a part of the housing portion 110f are clamped by the outwardly bent edge 121f and the flange 122f of the pressing portion 120f. The coupling portion 130f has an inner thread structure, for example, to assemble with a connector of an electronic device (not shown).

In this embodiment, the electrical connector 10f may further include an elastic sheet 400f. The elastic sheet 400f is disposed between the coupling portion 130f and the pressing portion 120f to stably secure the coupling portion 130f to the pressing portion 120f.

It should be noted that the elastic sheet 400f is an optional component and may be omitted in other embodiments.

The inner pressing sleeve 200f is slidably located in the installation space 111f, and includes an annular fastening portion 210f and a plurality of elastic clamping portions 220f connected to the annular fastening portion 210f. The elastic clamping portions 220f extend in a same direction from the annular fastening portion 210f and are separated from each other in a circumferential direction of the annular fastening portion 210f. Thicknesses of the elastic clamping portions 220f gradually increases in a direction away from the annular fastening portion 210f. In other embodiments, the thicknesses of the elastic clamping portions 220f may gradually decrease or remain uniform in the direction away from the annular fastening portion 210f.

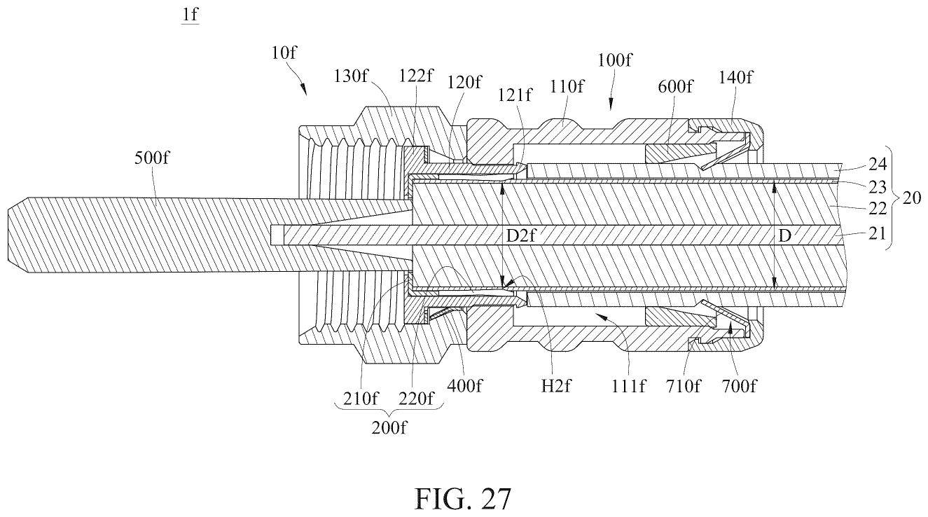

In this embodiment, the electrical connector 10f may further include a guide component 500f. The guide component 500f is made, for example, of an electrically insulating material, such as plastic. The annular fastening portion 210f of the inner pressing sleeve 200f may have a mount hole 211f, and the guide component 500f is movably and removed disposed in the mount hole 211f. The guide component 500f is configured to guide the assembly of a cable 20 (as shown in FIG. 27).

Furthermore, the electrical connector 10f may further include an annular elastic component 700f, and the casing 100f may further include a fastening cover portion 140f. The annular elastic component 700f is mounted at one end of the housing portion 110f via the fastening cover portion 140f, and the annular elastic component 700f is rotatable relative to the housing portion 110f and the fastening cover portion 140f. The annular elastic component 700f has a plurality of elastic arms 710f for stably securing the cable 20. It should be noted that the annular elastic component 700f and the fastening cover portion 140f are optional components and may be omitted in other embodiments.

Moreover, the electrical connector 10f may further include a fastening ring 600f. The fastening ring 600f is disposed in the installation space 111f. An inner diameter of the fastening ring 600f gradually increases along a direction away from the coupling portion 130f. The fastening ring 600f is configured to stably secure the cable 20. It should be noted that the fastening ring 600f is an optional component and may be omitted in other embodiments.

Then, referring to FIGS. 26 and 27, FIG. 27 is a cross-sectional view of the electrical connector in FIG. 25 which is assembled with a cable. The electrical connector 10f is configured to be assembled with the cable 20, thereby forming a cable assembly 1f together with the cable 20. The cable 20 includes, in order from inside to outside, a conductive core 21, an insulation layer 22, a braided mesh layer 23 (serving as a shielding layer) and an outer layer 24. At one end of the cable 20, the conductive core 21, the insulation layer 22 and the braided mesh layer 23 may be exposed from the outer layer 24.

The following describes the process of assembling the cable 20 to the electrical connector 10f. First, as shown in FIG. 26, when the cable 20 has not yet been inserted into the electrical connector 10f, the inner pressing sleeve 200f is positioned in a non-pressed position, so that the elastic clamping portions 220f of the inner pressing sleeve 200f are not pressed by the pressing portion 120f of the casing 100f. This allows sides of the elastic clamping portions 220f located farther away from the annular fastening portion 210f to form an installation through hole H1f. An inner diameter D1f of the installation through hole H1f is equal to or greater than an outer diameter D of the braided mesh layer 23 of the cable 20.

Next, as shown in FIG. 27, after the cable 20 is inserted into the installation space 111f of the housing portion 110f through a through hole of the fastening cover portion 140f of the casing 100f, the conductive core 21, exposed from the outer layer 24 of the cable 20, is inserted into the guide component 500f. Then, the cable 20, the guide component 500f and the inner pressing sleeve 200f are moved together. Next, the elastic clamping portions 220f of the moving inner pressing sleeve 200f come into contact with the pressing portion 120f of the casing 100f and are temporarily stopped. At this moment, continuing to push the cable 20 causes the cable 20 and the guide component 500f to move relative to the inner pressing sleeve 200f until the cable 20 comes into contact with the annular fastening portion 210f of the inner pressing sleeve 200f through the installation through hole H1f. Then, further pushing the cable 20 forces the inner pressing sleeve 200f to move, causing the elastic clamping portions 220f of the inner pressing sleeve 200f to be pressed by the pressing portion 120f of the casing 100f, thereby forming a clamping hole H2f. In this case, the inner diameter D1f of the installation through hole H1f is greater than an inner diameter D2f of the clamping hole H2f. As a result, the elastic clamping portions 220f of the inner pressing sleeve 200f tightly clamp the braided mesh layer 23 of the cable 20.

In this embodiment, the annular fastening portion 210f of the inner pressing sleeve 200f is slidable relative to the housing portion 110f of the casing 100f, allowing the elastic clamping portions 220f to form the installation through hole H1f when not pressed by the pressing portion 120f of the casing 100f and to form the clamping hole H2f when pressed by the pressing portion 120f, and the inner diameter D1f of the installation through hole H1f is greater than the inner diameter D2f of the clamping hole H2f. This arrangement allows, during the process of inserting the cable 20 into the inner pressing sleeve 200f through the installation space 111f of the housing portion 110f, the elastic clamping portions 220f of the inner pressing sleeve 200f to be pressed by the pressing portion 120f of the casing 100f, thereby tightly clamping the braided mesh layer 23 of the cable 20. In this way, the braided mesh layer 23 of the cable 20 does not need to be folded back, as the elastic clamping portions 220f of the inner pressing sleeve 200f are pressed by the pressing portion 120f of the casing 100f to tightly clamp the braided mesh layer 23 of the cable 20, ensuring an electrical contact between the inner pressing sleeve 200f and the braided mesh layer 23 of the cable 20. Therefore, the step of folding back the braided mesh layer 23 of the cable 20 during the assembly of the cable 20 to the electrical connector 10f is saved, improving the assembly efficiency.

In this embodiment, when the cable assembly 1f is required to be assembled with the connector of the electronic device, the guide component 500f of the electrical connector 10f needs to be removed from the inner pressing sleeve 200f, so that the conductive core 21 of the cable 20 can electrically contact a terminal of the connector of the electronic device. It should be noted that the guide component 500f is an optional component and may be omitted in other practical application examples.

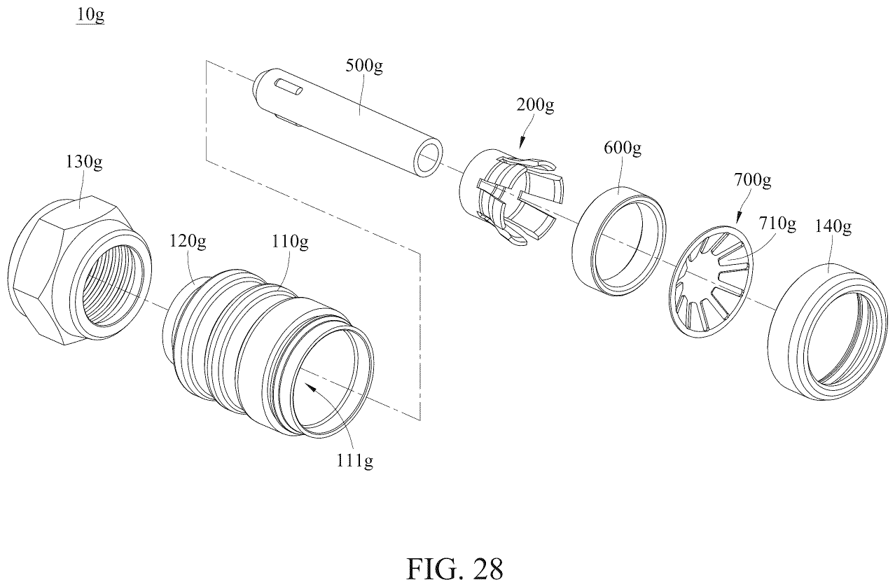

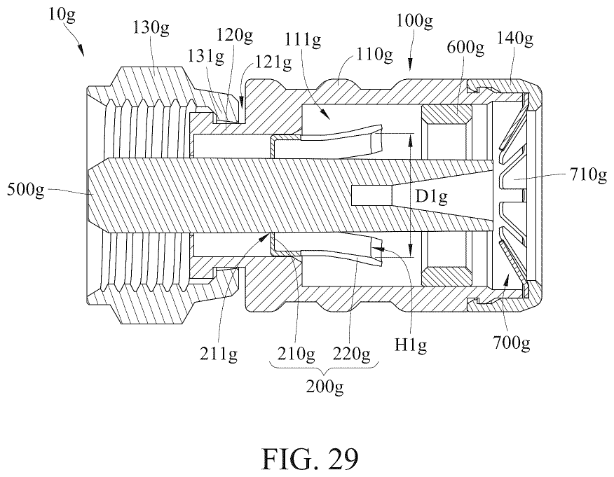

Then, referring to FIGS. 28 and 29, FIG. 28 is an exploded view of an electrical connector according to a seventh embodiment of the disclosure, and FIG. 29 is a cross-sectional view of the electrical connector in FIG. 28.

In this embodiment, the electrical connector 10g includes a casing 100g and an inner pressing sleeve 200g.

The casing 100g includes a housing portion 110g and a pressing portion 120g. The housing portion 110g has an installation space 111g, and the pressing portion 120g is at least partially located in the installation space 111g. For example, the pressing portion 120g is integrally formed with the housing portion 110g and extends from the installation space 111g of the housing portion 110g to the outside of the housing portion 110g. The casing 100g may further include a coupling portion 130g, and the coupling portion 130g has a positioning bent part 131g. The pressing portion 120g has a positioning recess 121g at a portion thereof located outside the housing portion 110g. The coupling portion 130g is rotatably disposed on the part of the pressing portion 120g that is located outside the housing portion 110g via the positioning bent part 131g and the positioning recess 121g. The coupling portion 130g has an inner thread structure, for example, to assemble with a connector of an electronic device (not shown).

The inner pressing sleeve 200g is slidably located in the installation space 111g, and includes an annular fastening portion 210g and a plurality of elastic clamping portions 220g connected to the annular fastening portion 210g. The elastic clamping portions 220g extend in a same direction from the annular fastening portion 210g and are separated from each other in a circumferential direction of the annular fastening portion 210g. Thicknesses of the elastic clamping portions 220g gradually increases in a direction away from the annular fastening portion 210g. In other embodiments, the thicknesses of the elastic clamping portions 220g may gradually decrease or remain uniform in the direction away from the annular fastening portion 210g.

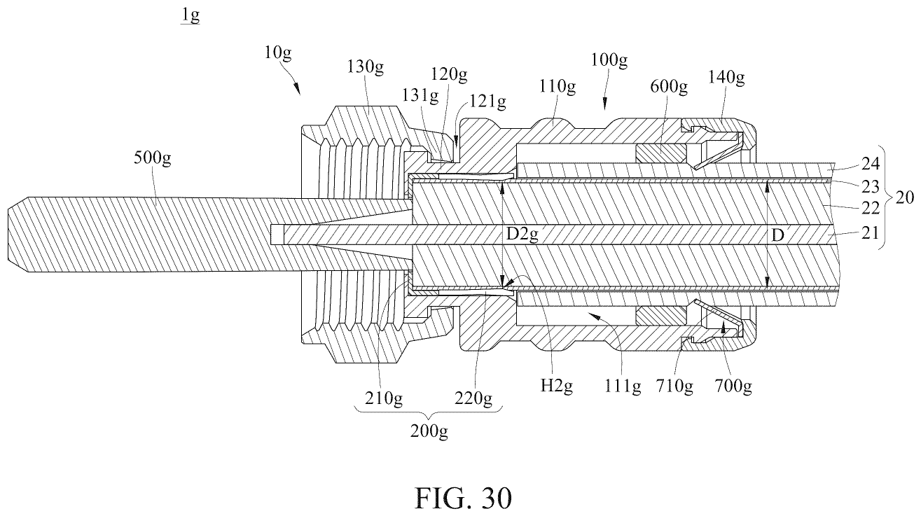

In this embodiment, the electrical connector 10g may further include a guide component 500g. The guide component 500g is made, for example, of an electrically insulating material, such as plastic. The annular fastening portion 210g of the inner pressing sleeve 200g may have a mount hole 211g, and the guide component 500g is movably and removed disposed in the mount hole 211g. The guide component 500g is configured to guide the assembly of a cable 20 (as shown in FIG. 30).

Furthermore, the electrical connector 10g may further include an annular elastic component 700g, and the casing 100g may further include a fastening cover portion 140g. The annular elastic component 700g is mounted at one end of the housing portion 110g via the fastening cover portion 140g, and the annular elastic component 700g is rotatable relative to the housing portion 110g and the fastening cover portion 140g. The annular elastic component 700g has a plurality of elastic arms 710g for stably securing the cable 20. It should be noted that the annular elastic component 700g and the fastening cover portion 140g are optional components and may be omitted in other embodiments.

Moreover, the electrical connector 10g may further include a fastening ring 600g. The fastening ring 600g is disposed in the installation space 111g for stably securing the cable 20. It should be noted that the fastening ring 600g is an optional component and may be omitted in other embodiments.

Then, referring to FIGS. 29 and 30, FIG. 30 is a cross-sectional view of the electrical connector in FIG. 28 which is assembled with a cable. The electrical connector 10g is configured to be assembled with the cable 20, thereby forming a cable assembly 1g together with the cable 20. The cable 20 includes, in order from inside to outside, a conductive core 21, an insulation layer 22, a braided mesh layer 23 (serving as a shielding layer) and an outer layer 24. At one end of the cable 20, the conductive core 21, the insulation layer 22 and the braided mesh layer 23 may be exposed from the outer layer 24.

The following describes the process of assembling the cable 20 to the electrical connector 10g. First, as shown in FIG. 29, when the cable 20 has not yet been inserted into the electrical connector 10g, the inner pressing sleeve 200g is positioned in a non-pressed position, so that the elastic clamping portions 220g of the inner pressing sleeve 200g are not pressed by the pressing portion 120g of the casing 100g. This allows sides of the elastic clamping portions 220g located farther away from the annular fastening portion 210g to form an installation through hole H1g. An inner diameter D1g of the installation through hole H1g is equal to or greater than an outer diameter D of the braided mesh layer 23 of the cable 20.

Next, as shown in FIG. 30, after the cable 20 is inserted into the installation space 111g of the housing portion 110g through a through hole of the fastening cover portion 140g of the casing 100g, the conductive core 21, exposed from the outer layer 24 of the cable 20, is inserted into the guide component 500g. Then, the cable 20, the guide component 500g and the inner pressing sleeve 200g are moved together. Next, the elastic clamping portions 220g of the moving inner pressing sleeve 200g come into contact with the pressing portion 120g of the casing 100g and are temporarily stopped. At this moment, continuing to push the cable 20 causes the cable 20 and the guide component 500g to move relative to the inner pressing sleeve 200g until the cable 20 comes into contact with the annular fastening portion 210g of the inner pressing sleeve 200g through the installation through hole H1g. Then, further pushing the cable 20 forces the inner pressing sleeve 200g to move, causing the elastic clamping portions 220g of the inner pressing sleeve 200g to be pressed by the pressing portion 120g of the casing 100g, thereby forming a clamping hole H2g. In this case, the inner diameter D1g of the installation through hole H1g is greater than an inner diameter D2g of the clamping hole H2g. As a result, the elastic clamping portions 220g of the inner pressing sleeve 200g tightly clamp the braided mesh layer 23 of the cable 20.

In this embodiment, the annular fastening portion 210g of the inner pressing sleeve 200g is slidable relative to the housing portion 110g of the casing 100g, allowing the elastic clamping portions 220g to form the installation through hole H1g when not pressed by the pressing portion 120g of the casing 100g and to form the clamping hole H2g when pressed by the pressing portion 120g, and the inner diameter D1g of the installation through hole H1g is greater than the inner diameter D2g of the clamping hole H2g. This arrangement allows, during the process of inserting the cable 20 into the inner pressing sleeve 200g through the installation space 111g of the housing portion 110g, the elastic clamping portions 220g of the inner pressing sleeve 200g to be pressed by the pressing portion 120g of the casing 100g, thereby tightly clamping the braided mesh layer 23 of the cable 20. In this way, the braided mesh layer 23 of the cable 20 does not need to be folded back, as the elastic clamping portions 220g of the inner pressing sleeve 200g are pressed by the pressing portion 120g of the casing 100g to tightly clamp the braided mesh layer 23 of the cable 20, ensuring an electrical contact between the inner pressing sleeve 200g and the braided mesh layer 23 of the cable 20. Therefore, the step of folding back the braided mesh layer 23 of the cable 20 during the assembly of the cable 20 to the electrical connector 10g is saved, improving the assembly efficiency.

In this embodiment, when the cable assembly 1g is required to be assembled with the connector of the electronic device, the guide component 500g of the electrical connector 10g needs to be removed from the inner pressing sleeve 200g, so that the conductive core 21 of the cable 20 can electrically contact a terminal of the connector of the electronic device. It should be noted that the guide component 500g is an optional component and may be omitted in other practical application examples.

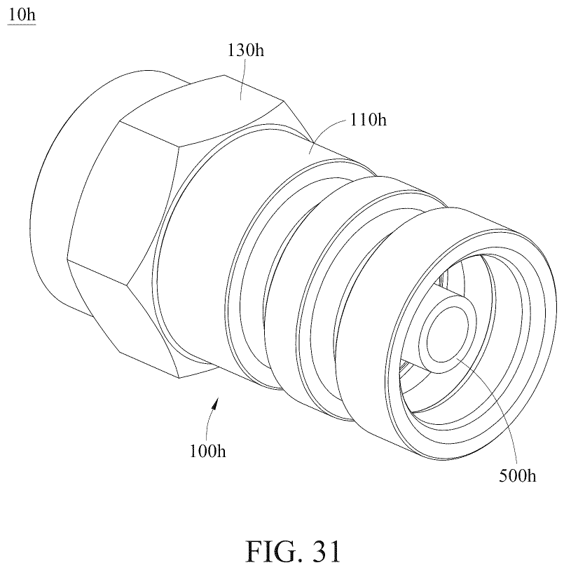

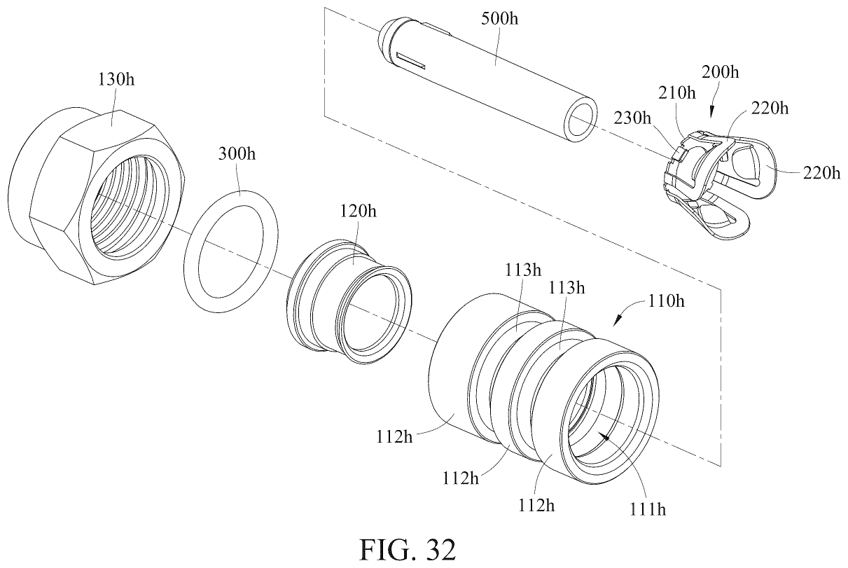

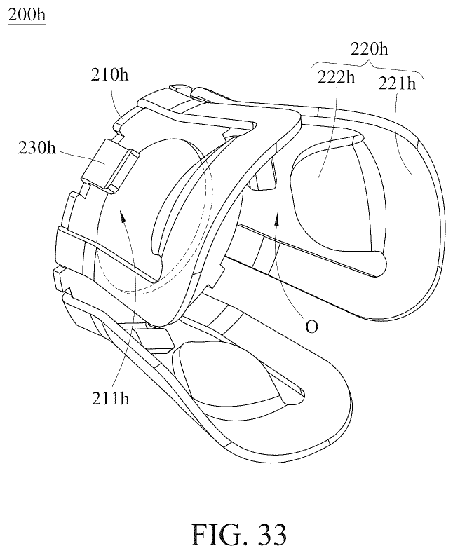

Then, referring to FIGS. 31 to 33, FIG. 31 is a perspective view of an electrical connector according to an eighth embodiment of the disclosure, FIG. 32 is an exploded view of the electrical connector in FIG. 31, and FIG. 33 is a perspective view of an inner pressing sleeve in FIG. 32.

In this embodiment, the electrical connector 10h includes a casing 100h and an inner pressing sleeve 200h.

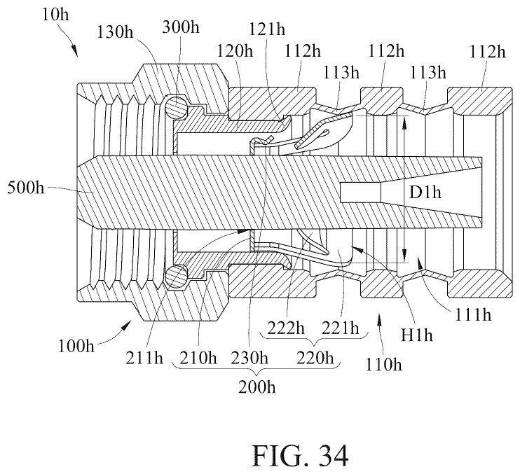

Then, referring to FIGS. 32 and 34, FIG. 34 is a cross-sectional view of the electrical connector in FIG. 31.

The casing 100h includes a housing portion 110h and a pressing portion 120h. The housing portion 110h has an installation space 111h, and the pressing portion 120h is at least partially located in the installation space 111h. For example, the housing portion 110h includes a plurality of ring parts 112h and a plurality of collapsible parts 113h. The ring parts 112h are axially connected via the collapsible parts 113h, and the ring parts 112h and the the collapsible parts 113h together form the installation space 111h. The pressing portion 120h and the housing portion 110h are made of two pieces, and the pressing portion 120h extends from the installation space 111h of the housing portion 110h to the outside of the housing portion 110h. The pressing portion 120h has an outwardly bent edge 121h at one end thereof located in the installation space 111h. The casing 100h may further include a coupling portion 130h, and the electrical connector 10h may further include an O-ring 300h. The coupling portion 130h is rotatably disposed on the part of the pressing portion 120h located outside the housing portion 110h, and a part of the coupling portion 130h and a part of the housing portion 110h are clamped by the outwardly bent edge 121h of the pressing portion 120h and the O-ring 300h. The coupling portion 130h has an inner thread structure, for example, to assemble with a connector of an electronic device (not shown).

It should be noted that the O-ring 300h is an optional component and may be omitted in other embodiments.

As shown in FIG. 32 to FIG. 34, the inner pressing sleeve 200h is slidably located in the installation space 111h and includes an annular fastening portion 210h and a plurality of elastic clamping portions 220h connected to the annular fastening portion 210h. The elastic clamping portions 220h extend in a same direction from the annular fastening portion 210h and are spaced apart from each other in a circumferential direction of the annular fastening portion 210h. Each of the elastic clamping portions 220h includes a peripheral part 221h and an inner arm part 222h. In one elastic clamping portion 220h, two ends of the peripheral part 221h are connected to the annular fastening portion 210h, the peripheral part 221h and the annular fastening portion 210h together form an opening O, and the inner arm part 222h is connected to the peripheral part 221h and located in the opening O. Furthermore, the inner pressing sleeve 200h may also include a plurality of elastic contact portions 230h. The elastic contact portions 230h are connected to the annular fastening portion 210h. Each of the elastic contact portions 230h is located in the opening O and located opposite to the inner arm part 222h.

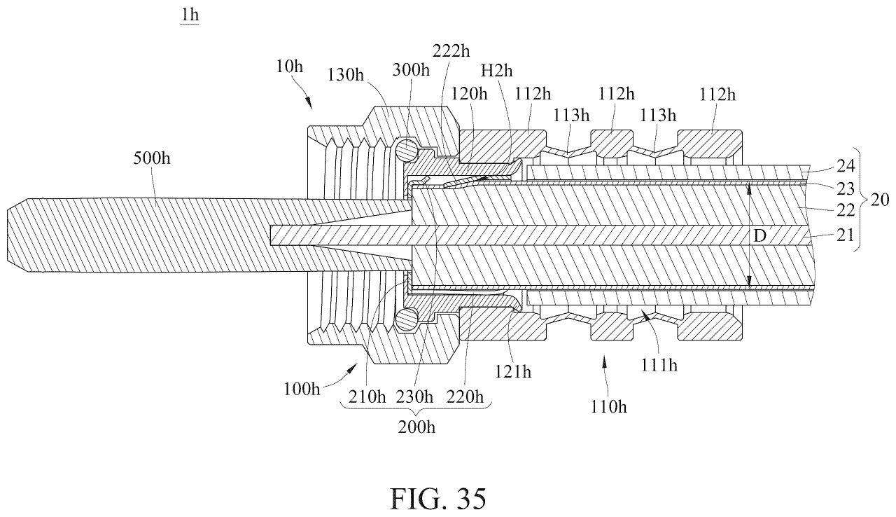

In this embodiment, the electrical connector 10h may further include a guide component 500h. The guide component 500h is made of an electrically insulating material, such as plastic. The annular fastening portion 210h of the inner pressing sleeve 200h may have a mount hole 211h, and the guide component 500h is movably and removably disposed in the mount hole 211h. The guide component 500h is configured to guide the assembly of a cable 20 (as shown in FIG. 35).

Then, referring to FIGS. 34 to 36, FIGS. 35 and 36 are a cross-sectional view of the electrical connector in FIG. 34 which is assembled with a cable.

The electrical connector 10h is configured to be assembled with the cable 20, thereby forming a cable assembly 1h together with the cable 20. The cable 20 includes, in order from inside to outside, a conductive core 21, an insulation layer 22, a braided mesh layer 23 (serving as a shielding layer) and an outer layer 24. At one end of the cable 20, the conductive core 21, the insulation layer 22 and the braided mesh layer 23 may be exposed from the outer layer 24.

The following describes the process of assembling the cable 20 to the electrical connector 10h. First, as shown in FIG. 34, when the cable 20 has not yet been inserted into the electrical connector 10h, the inner pressing sleeve 200h is positioned in a non-pressed position, so that the elastic clamping portions 220h of the inner pressing sleeve 200h are not pressed by the pressing portion 120h of the casing 100h. This allows sides of the elastic clamping portions 220h located farther away from the annular fastening portion 210h to form an installation through hole H1h. An inner diameter D1h of the installation through hole H1h is equal to or greater than an outer diameter D of the braided mesh layer 23 of the cable 20.

Next, as shown in FIG. 35, after the cable 20 is inserted into the installation space 111h of the housing portion 110h, the conductive core 21, exposed from the outer layer 24 of the cable 20, is inserted into the guide component 500h. Then, the cable 20, the guide component 500h and the inner pressing sleeve 200h are moved together. Next, the elastic clamping portions 220h of the moving inner pressing sleeve 200h come into contact with the pressing portion 120h of the casing 100h and are temporarily stopped. At this moment, continuing to push the cable 20 causes the cable 20 and the guide component 500h to move relative to the inner pressing sleeve 200h until the cable 20 comes into contact with the annular fastening portion 210h of the inner pressing sleeve 200h through the installation through hole H1h, and the elastic contact portions 230h contact the braided mesh layer 23 of the cable 20. Then, further pushing the cable 20 forces the inner pressing sleeve 200h to move, causing the elastic clamping portions 220h of the inner pressing sleeve 200h to be pressed by the pressing portion 120h of the casing 100h, thereby forming a clamping hole H2h. In this case, the inner diameter D1h of the installation through hole H1h is greater than an inner diameter (as shown in FIG. 11) of the clamping hole H2h. As a result, the elastic clamping portions 220h of the inner pressing sleeve 200h tightly clamp the braided mesh layer 23 of the cable 20.

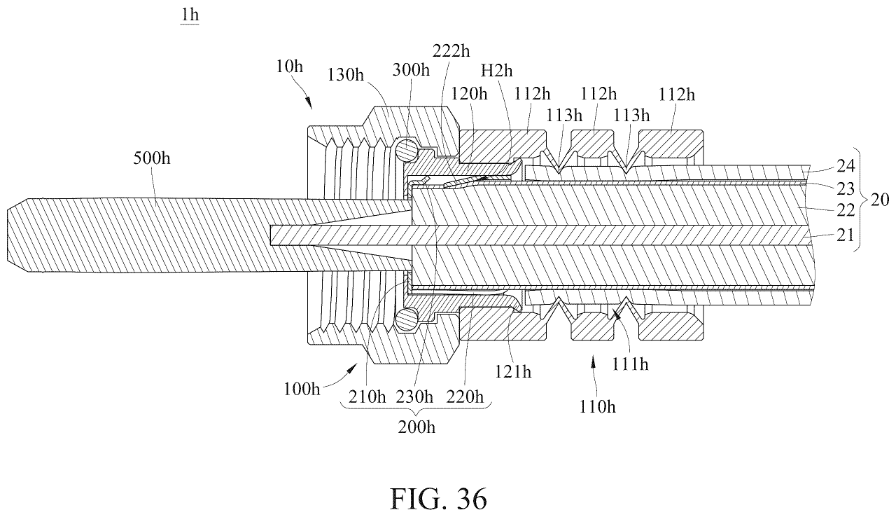

Then, as shown in FIG. 36, a tool is used to clamp the casing 100h along the axial direction of the electrical connector 10h, so that the collapsible parts 113h of the housing portion 110h of the casing 100h collapse axially and radially toward a central axis, thereby pressing against the outer layer 24 of the cable 20. In this way, the assembly of the cable 20 with the electrical connector 10h is completed.

In this embodiment, the annular fastening portion 210h of the inner pressing sleeve 200h is slidable relative to the housing portion 110h of the casing 100h, allowing the elastic clamping portions 220h to form the installation through hole H1h when not pressed by the pressing portion 120h of the casing 100h and to form the clamping hole H2h when pressed by the pressing portion 120h, and the inner diameter D1h of the installation through hole H1h is greater than the inner diameter of the clamping hole H2h. This arrangement allows, during the process of inserting the cable 20 into the inner pressing sleeve 200h through the installation space 111h of the housing portion 110h, the elastic clamping portions 220h of the inner pressing sleeve 200h to be pressed by the pressing portion 120h of the casing 100h, thereby tightly clamping the braided mesh layer 23 of the cable 20. In this way, the braided mesh layer 23 of the cable 20 does not need to be folded back, as the elastic clamping portions 220h of the inner pressing sleeve 200h are pressed by the pressing portion 120h of the casing 100h to tightly clamp the braided mesh layer 23 of the cable 20, ensuring an electrical contact between the inner pressing sleeve 200h and the braided mesh layer 23 of the cable 20. Therefore, the step of folding back the braided mesh layer 23 of the cable 20 during the assembly of the cable 20 to the electrical connector 10h is saved, improving the assembly efficiency.

In this embodiment, when the cable assembly 1h is required to be assembled with the connector of the electronic device, the guide component 500h of the electrical connector 10h needs to be removed from the inner pressing sleeve 200h, so that the conductive core 21 of the cable 20 can electrically contact a terminal of the connector of the electronic device. It should be noted that the guide component 500h is an optional component and may be omitted in other practical application examples.

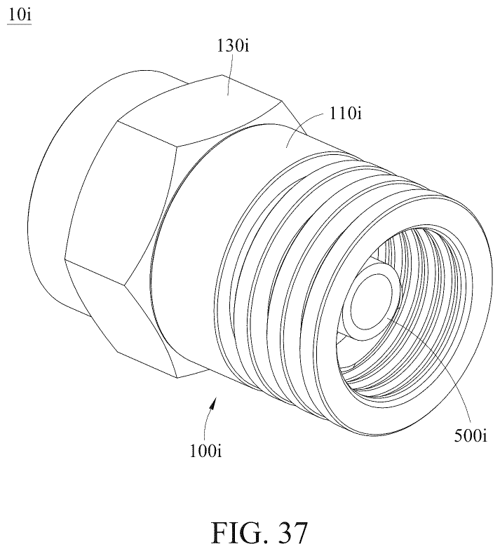

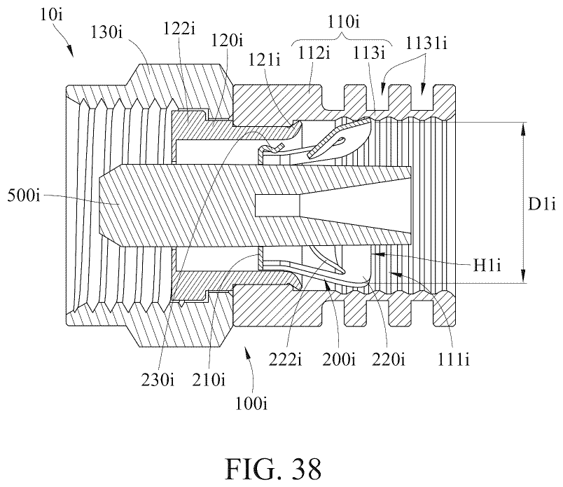

Referring to FIGS. 37 and 38, FIG. 37 is a perspective view of an electrical connector according to a ninth embodiment of the disclosure, and FIG. 38 is a cross-sectional view of the electrical connector in FIG. 37.

In this embodiment, the electrical connector 10i includes a casing 100i and an inner pressing sleeve 200i.

The casing 100i includes a housing portion 110i and a pressing portion 120i. The housing portion 110i has an installation space 111i, and the pressing portion 120i is at least partially located in the installation space 111i. For example, the housing portion 110i includes a ring part 112i and a collapsible part 113i axially connected to each other. The collapsible part 113i has a plurality of annular grooves 1131i arranged axially and spaced apart from one another. The ring part 112i and the collapsible part 113i together form the installation space 111i. The pressing portion 120i and the housing portion 110i are made of two pieces, and the pressing portion 120i extends from the installation space 111i of the housing portion 110i to the outside of the housing portion 110i. The pressing portion 120i has an outwardly bent edge 121i at one end thereof located in the installation space 111i, and the pressing portion 120i has a flange 122i at one end thereof located outside the installation space 111i. The casing 100i may further include a coupling portion 130i. The coupling portion 130i is rotatably disposed on the part of the pressing portion 120i that is located outside the housing portion 110i, and a part of the coupling portion 130i and a part of the housing portion 110i are clamped by the outwardly bent edge 121i and the flange 122i of the pressing portion 120i. The coupling portion 130i has an inner thread structure, for example, to assemble with a connector of an electronic device (not shown).

The inner pressing sleeve 200i has the same structure as that of the inner pressing sleeve 200h in the previous embodiment; hence, detailed introduction thereof is omitted.

In this embodiment, the electrical connector 10i may further include a guide component 500i. The assembly relationship between the guide component 500i and the inner pressing sleeve 200i is similar to that between the inner pressing sleeve 200h and the guide component 500h in the previous embodiment. Therefore, reference can be made to the relevant paragraphs of the previous embodiment, and a detailed description will not be repeated.

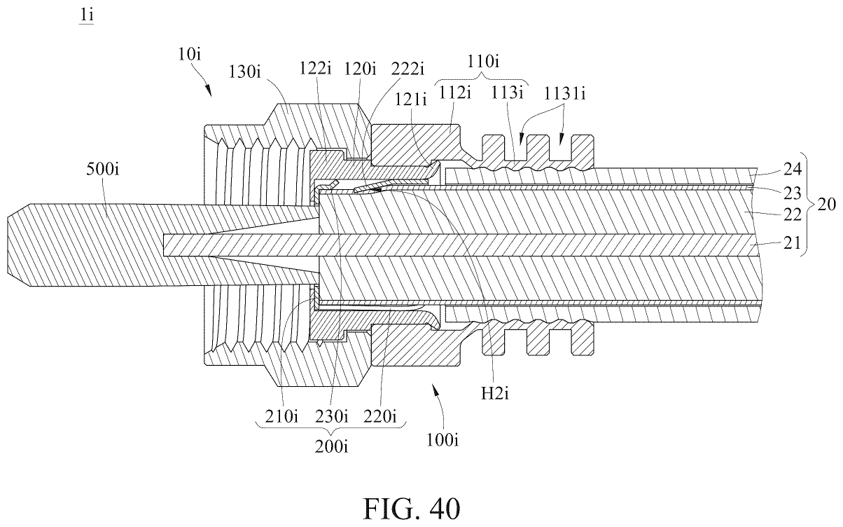

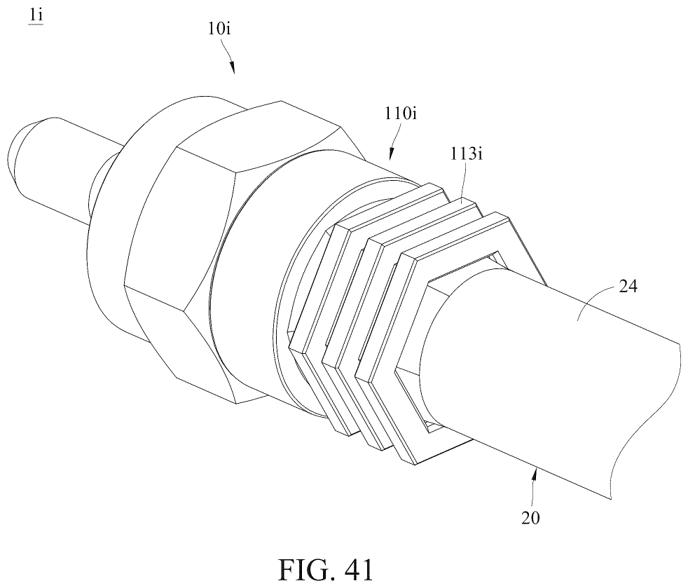

Then, referring to FIGS. 38 to 41, FIGS. 39 and 40 are a cross-sectional view of the electrical connector in FIG. 38 which is assembled with a cable, and FIG. 41 is a perspective view of the electrical connector and the cable in FIG. 40.

The electrical connector 10i is configured to be assembled with the cable 20, thereby forming a cable assembly 1i together with the cable 20. The cable 20 includes, in order from inside to outside, a conductive core 21, an insulation layer 22, a braided mesh layer 23 (serving as a shielding layer) and an outer layer 24. At one end of the cable 20, the conductive core 21, the insulation layer 22 and the braided mesh layer 23 may be exposed from the outer layer 24.

The following describes the process of assembling the cable 20 to the electrical connector 10i. First, as shown in FIG. 38, when the cable 20 has not yet been inserted into the electrical connector 10i, the inner pressing sleeve 200i is positioned in a non-pressed position, so that the elastic clamping portions 220i of the inner pressing sleeve 200i are not pressed by the pressing portion 120i of the casing 100i. This allows sides of the elastic clamping portions 220i located farther away from the annular fastening portion 210i to form an installation through hole H1i. An inner diameter D1i of the installation through hole H1i is equal to or greater than an outer diameter D of the braided mesh layer 23 of the cable 20.

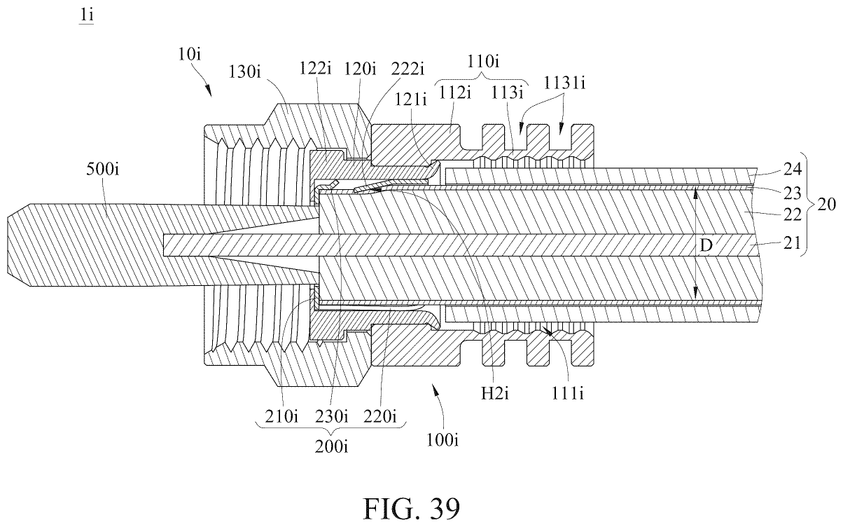

Next, as shown in FIG. 39, after the cable 20 is inserted into the installation space 111i of the housing portion 110i, the conductive core 21, exposed from the outer layer 24 of the cable 20, is inserted into the guide component 500i. Then, the cable 20, the guide component 500i and the inner pressing sleeve 200i are moved together. Next, the elastic clamping portions 220i of the moving inner pressing sleeve 200i come into contact with the pressing portion 120i of the casing 100i and are temporarily stopped. At this moment, continuing to push the cable 20 causes the cable 20 and the guide component 500i to move relative to the inner pressing sleeve 200i until the cable 20 comes into contact with the annular fastening portion 210i of the inner pressing sleeve 200i through the installation through hole H1i, and the elastic contact portions 230i contact the braided mesh layer 23 of the cable 20. Then, further pushing the cable 20 forces the inner pressing sleeve 200i to move, causing the elastic clamping portions 220i of the inner pressing sleeve 200i to be pressed by the pressing portion 120i of the casing 100i, thereby forming a clamping hole H2i. In this case, the inner diameter D1i of the installation through hole H1i is greater than an inner diameter (as shown in FIG. 11) of the clamping hole H2i. As a result, the elastic clamping portions 220i of the inner pressing sleeve 200i tightly clamp the braided mesh layer 23 of the cable 20.

As shown in FIGS. 40 and 41, a tool is used to radially clamp the collapsible part 113i of the housing portion 110i of the electrical connector 10i, causing the collapsible part 113i to collapse radially, for example, into a hexagonal shape, so as to press against the outer layer 24 of the cable 20. In this way, the assembly of the cable 20 with the electrical connector 10i is completed. In other embodiments, the collapsible part may have any geometric shape (e.g., circular, triangular, etc.) to press against the outer layer of the cable for assembly purposes.

In this embodiment, the annular fastening portion 210i of the inner pressing sleeve 200i is slidable relative to the housing portion 110i of the casing 100i, allowing the elastic clamping portions 220i to form the installation through hole H1i when not pressed by the pressing portion 120i of the casing 100i and to form the clamping hole H2i when pressed by the pressing portion 120i, and the inner diameter D1i of the installation through hole H1i is greater than the inner diameter of the clamping hole H2i. This arrangement allows, during the process of inserting the cable 20 into the inner pressing sleeve 200i through the installation space 111i of the housing portion 110i, the elastic clamping portions 220i of the inner pressing sleeve 200i to be pressed by the pressing portion 120i of the casing 100i, thereby tightly clamping the braided mesh layer 23 of the cable 20. In this way, the braided mesh layer 23 of the cable 20 does not need to be folded back, as the elastic clamping portions 220i of the inner pressing sleeve 200i are pressed by the pressing portion 120i of the casing 100i to tightly clamp the braided mesh layer 23 of the cable 20, ensuring an electrical contact between the inner pressing sleeve 200i and the braided mesh layer 23 of the cable 20. Therefore, the step of folding back the braided mesh layer 23 of the cable 20 during the assembly of the cable 20 to the electrical connector 10i is saved, improving the assembly efficiency.

In this embodiment, when the cable assembly 1i is required to be assembled with the connector of the electronic device, the guide component 500i of the electrical connector 10i needs to be removed from the inner pressing sleeve 200i, so that the conductive core 21 of the cable 20 can electrically contact a terminal of the connector of the electronic device. It should be noted that the guide component 500i is an optional component and may be omitted in other practical application examples.

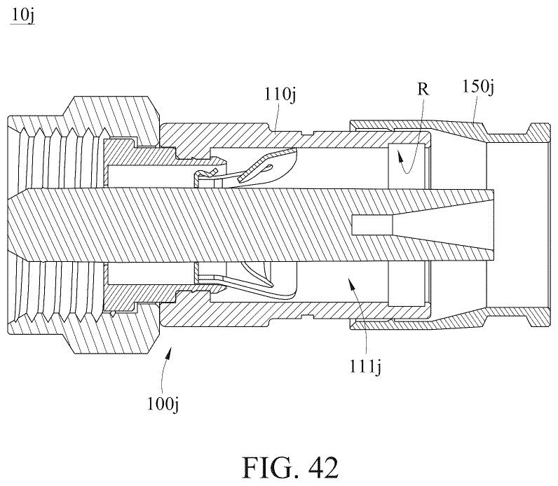

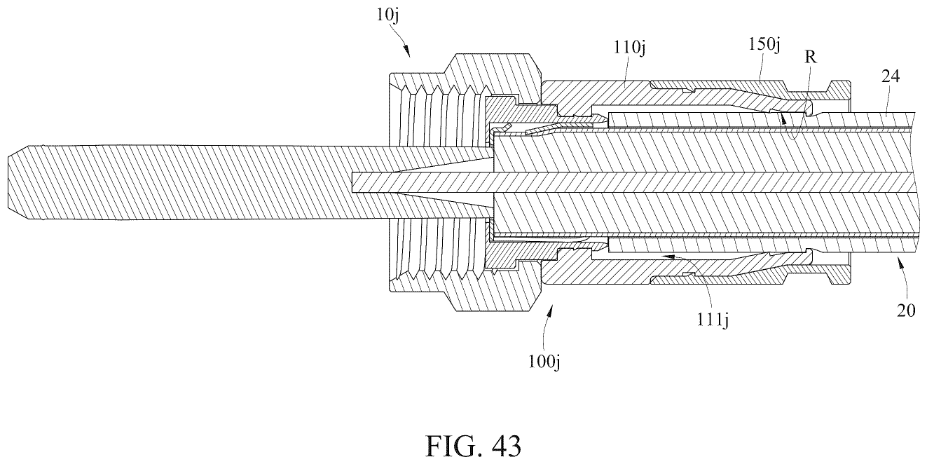

Then, referring to FIGS. 42 and 43, FIG. 42 is a cross-sectional view of an electrical connector according to tenth embodiment of the disclosure, and FIG. 43 is a cross-sectional view of the electrical connector in FIG. 42 which is assembled with a cable.

The electrical connector 10j of this embodiment is similar to the electrical connector 10i of the previous embodiment, and the main difference between them lies in the structure of the casing. Therefore, the following description will mainly focus on a casing 100j of the electrical connector 10j, while the other parts can be referred to in the description of the previous embodiment and will not be repeated hereinafter.

In this embodiment, the casing 100j further includes an outer sleeve portion 150j. The outer sleeve portion 150j is sleeved on and presses against one end of a housing portion 110j, thereby forcing that end of the housing portion 110j to deform radially and press against the outer layer 24 of the cable 20. That end of the housing portion 110j has an annular inner groove R radially connected to an installation space 111j. The annular inner groove R is configured to accommodate a part of the cable 20.

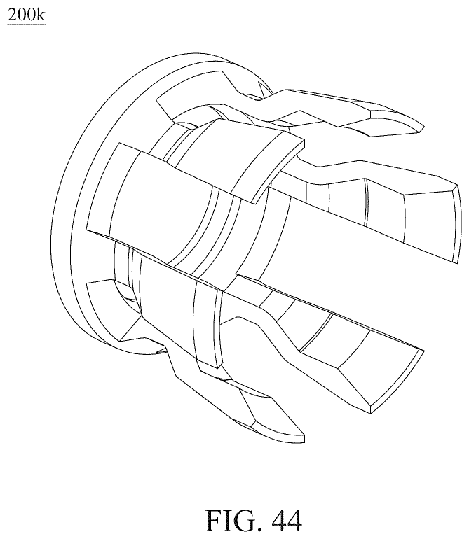

Referring to FIG. 44, FIG. 44 is a perspective view of an inner pressing sleeve according to an eleventh embodiment of the disclosure.

An inner pressing sleeve 200k of this embodiment is similar to the inner pressing sleeve 200a shown in FIG. 2. The main difference between them lies in their appearance. In this embodiment, the inner pressing sleeve 200k features elastic clamping portions in a curved shape, making them more suitable for clamping a thinner cable. The detailed structure of the inner pressing sleeve 200k is not further described hereinafter. It should be noted that the inner pressing sleeve 200k of this embodiment can be used as a substitute for the inner pressing sleeves in the aforementioned embodiments.

According to the electrical connectors and the cable assemblies as discussed in the above embodiments, the annular fastening portion of the inner pressing sleeve is slidable relative to the housing portion of the casing, allowing the elastic clamping portions to form the installation through hole when not pressed by the pressing portion of the casing and to form the clamping hole when pressed by the pressing portion, and the inner diameter of the installation through hole is greater than the inner diameter of the clamping hole. This arrangement allows, during the process of inserting the cable into the inner pressing sleeve through the installation space of the housing portion, the elastic clamping portions of the inner pressing sleeve to be pressed by the pressing portion of the casing, thereby tightly clamping the braided mesh layer of the cable. In this way, the braided mesh layer of the cable does not need to be folded back, as the elastic clamping portions of the inner pressing sleeve are pressed by the pressing portion of the casing to tightly clamp the braided mesh layer of the cable, ensuring an electrical contact between the inner pressing sleeve and the braided mesh layer of the cable. Therefore, the step of folding back the braided mesh layer of the cable during the assembly of the cable to the electrical connector is saved, improving the assembly efficiency.

In addition, the guide component of the electrical connector can guide the assembly of the cable. When the cable assembly is required to be assembled with the connector of the electronic device, the guide component of the electrical connector needs to be removed from the inner pressing sleeve, so that the conductive core of the cable can electrically contact the terminal of the connector of the electronic device.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. An electrical connector, configured to be assembled with a cable, comprising:
a casing, comprising a housing portion and a pressing portion, wherein the housing portion has an installation space, and the pressing portion is at least partially located in the installation space; and
an inner pressing sleeve, located in the installation space and comprising an annular fastening portion and at least one elastic clamping portion connected to each other, wherein the annular fastening portion is slidable relative to the housing portion for allowing the at least one elastic clamping portion to form an installation through hole when the at least one elastic clamping portion is not pressed by the pressing portion and allowing the at least one elastic clamping portion to form a clamping hole when the at least one elastic clamping portion is pressed by the pressing portion, wherein an inner diameter of the installation through hole is greater than an inner diameter of the clamping hole.

2. The electrical connector according to claim 1, wherein the at least one elastic clamping portion comprises a plurality of elastic clamping portions, the plurality of elastic clamping portions extend from the annular fastening portion along a same direction, the plurality of elastic clamping portions are spaced part from each other, and the installation through hole is formed at sides of the plurality of elastic clamping portions located farther away from the annular fastening portion.

3. The electrical connector according to claim 2, wherein each of the plurality of elastic clamping portions comprises a peripheral part and an inner arm part, two ends of the peripheral part are connected to the annular fastening portion, the peripheral part and the annular fastening portion together form an opening, and the inner arm part is connected to the peripheral part and movably located in the opening.

4. The electrical connector according to claim 3, wherein the inner pressing sleeve further comprises a plurality of elastic contact portions, the plurality of elastic contact portions are connected to the annular fastening portion, and each of the plurality of elastic contact portions is located in the opening and located opposite to the inner arm part.

5. The electrical connector according to claim 2, wherein the plurality of elastic clamping portions are in a wavy shape.

6. The electrical connector according to claim 1, wherein the annular fastening portion comprises a base and an annular wall, the annular wall is connected to a periphery of the base, the annular wall has a plurality of openings, the plurality of openings are spaced apart from one another in a circumferential direction of the annular wall, the at least one elastic clamping portion comprises a plurality of elastic clamping portions, the plurality of elastic clamping portions are connected to the annular wall and are movably located in the plurality of openings, respectively, and the installation through hole and the clamping hole are formed at sides of the plurality of elastic clamping portions located farther away from the annular fastening portion.

7. The electrical connector according to claim 1, wherein the casing further comprises a coupling portion, the pressing portion extends to outside of the housing portion from the installation space of the housing portion, and the coupling portion is rotatably disposed on a part of the pressing portion located outside the housing portion.

8. The electrical connector according to claim 7, wherein the pressing portion is integrally formed with the housing portion.

9. The electrical connector according to claim 8, further comprising a positioning component, wherein the coupling portion is positioned on the pressing portion via the positioning component.

10. The electrical connector according to claim 7, wherein the pressing portion and the housing portion are made of two pieces.

11. The electrical connector according to claim 10, further comprising an elastic sheet, wherein the elastic sheet is disposed between the coupling portion and the pressing portion to stably secure the coupling portion to the pressing portion.

12. The electrical connector according to claim 10, wherein the pressing portion has an outwardly bent edge at one end thereof located in the installation space.

13. The electrical connector according to claim 1, further comprising a guide component, wherein the annular fastening portion of the inner pressing sleeve has a mount hole, and the guide component is movably and removably disposed in the mount hole.

14. The electrical connector according to claim 1, further comprising a fastening ring, wherein the fastening ring is disposed in the installation space for stably securing the cable.

15. The electrical connector according to claim 1, further comprising an annular elastic component, wherein the casing further comprises a fastening cover portion, the annular elastic component is mounted at one end of the housing portion via the fastening cover portion, the annular elastic component is rotatable relative to the housing portion and the fastening cover portion, and the annular elastic component has a plurality of movable arms for stably securing the cable.

16. The electrical connector according to claim 1, wherein the housing portion comprises a plurality of ring parts and at least one collapsible part, the plurality of ring parts are axially connected via the at least one collapsible part, and the at least one collapsible part is collapsible axially and radially toward a central axis to press against the cable.

17. The electrical connector according to claim 1, wherein the housing portion comprises a ring part and a collapsible part axially connected to each other, the collapsible part has a plurality of annular grooves arranged axially and spaced apart from one another, and the collapsible part is collapsible radially to press against the cable.

18. The electrical connector according to claim 1, wherein the casing further comprises an outer sleeve portion, the outer sleeve portion is sleeved on and presses against one end of the housing portion to radially deform the end of the housing portion to press against the cable, the end of the housing portion has an annular inner groove radially connected to the installation space, and the annular inner groove is configured to accommodate a portion of the cable.

19. The electrical connector according to claim 1, wherein the inner diameter of the installation through hole is equal to or greater than an outer diameter of a shielding layer of the cable.

20. A cable assembly, comprising:
an electrical connector, comprising:
a casing, comprising a housing portion and a pressing portion, wherein the housing portion has an installation space, and the pressing portion is at least partially located in the installation space; and
an inner pressing sleeve, slidably located in the installation space and comprising an annular fastening portion and at least one elastic clamping portion connected to each other; and
a cable, mounted into the inner pressing sleeve through the installation space of the housing portion, wherein the at least one elastic clamping portion is pressed by the pressing portion so as to form a clamping hole to clamp the cable.
